(19) United States
(12) Patent Application Publication
(10) Pub. No.: US 2005/0057133 A1
(43) Pub. Date: Mar. 17, 2005

(54) Spark plug and related manufacturing method

(75) Inventor: Tsunenobu Hori, Kariya-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/929,515

(22) Filed: Aug. 31, 2004

(30) Foreign Application Priority Data
Sep. 17, 2003 (JP) 2003-324588

(51) Int. Cl. H01T 21/02; H01T 13/20

(52) U.S. Cl. 313/141; 313/142; 313/143; 445/7

(57) ABSTRACT

A spark plug and manufacturing method are disclosed having a center electrode and a ground electrode to which a center-electrode noble metal chip and a ground-electrode noble metal chip are secured, respectively, by welding. The center-electrode noble metal chip has a bending strength defined by a coefficient of linear expansion of the center electrode, a coefficient of linear expansion of the center-electrode noble metal chip, a Young's modulus, a tensile strength, a chip diameter, a chip protruding length and a thickness of a fused portion, and the ground-electrode noble metal chip has a bending strength defined by a coefficient of linear expansion of the ground electrode, a coefficient of linear expansion of the ground-electrode noble metal chip, a Young's modulus, a tensile strength of the second noble metal chip, a chip diameter, a chip protruding length and a thickness of a fused portion.

### BACKGROUND OF THE INVENTION

1. Field of the Invention

The present invention relates to spark plugs and related manufacturing methods and, more particularly, to a spark plug for an internal combustion engine, wherein metal chips each with a narrow profile are secured to a center electrode and a ground electrode to enhance ignitability while improving a reliability of the bond between the metal chip and the ground electrode to match the engine subjected to further increased thermal load than the related art engine, and a related manufacturing method.

2. Description of the Related Art

Considerable research and development work has heretofore been undertaken in the past to provide a spark plug wherein a center electrode and ground electrode are arranged to protrude from respective electrode support sections while allowing the electrodes to have narrowed profiles to realize high ignitability as disclosed in Japanese Patent Provisional Publication No. 52-36237 (U.S. Pat. No. 4,109,633 issued to Mitsudo et al).

In such a spark plug, in order to enhance wear resistance, various attempts have been made to include a narrowed electrode, made of noble metal chip including, for instance, Pt, Pd, Au or alloys thereof, which is secured to the center electrode or ground electrode. Such securing may be achieved by various techniques involving welding, driving, press fitting or squeezing followed by caulking.

However, due to a trend in modern engines designed to provide high power output, low fuel consumption and low exhaust emissions in recent years, the engine operates under combustion environments at a higher temperature than the related art engine. With the engine in such a structure, the center electrode and the ground electrode of the spark plug are subjected to an extremely high temperature, exposing various issues such as the occurrence of dropoff of the noble metal chip, secured to the electrode, from base material in the presence of thermal stress and oxidation at these high temperatures.

Therefore, in order to improve a bonding reliability of the spark plug, various proposals have been made to provide welding techniques for limiting a cross sectional dimension of the fused portion, when securing the noble metal chip to the ground electrode, to lower thermal stress being applied to the noble metal chip in the engine under severe thermal load conditions for thereby suppressing breakaway (separation) of the noble metal chip (see Japanese Patent Provisional Publication No. 2002-237365 (U.S. Patent Application Publication No. 2002/0105254A1) assigned to the same assignee of this application).

However, although the above U.S. Patent Publication discusses the formation of the limited cross sectional area of the fused portion between the noble metal chip and the ground electrode, there is no description for electrode base material and material characteristics of the noble metal chip that form principal factors of thermal stress, and no adequate solution is made to enhance the bonding reliability of the noble metal chip.

### SUMMARY OF THE INVENTION

The present invention has been completed with the above view in mind and has an object to provide a spark plug that has a center electrode and a ground electrode to which noble metal chips are welded as spark discharge members to realize improved bonding reliability of the noble metal chip, and a related manufacturing method.

To achieve the above object, considerable study work has been undertaken by the present inventors to find correlation between a physical value of electrode material and bonding reliability in view of welding and bending strength of the noble metal chip and depending upon the results of the study.

According to a first aspect of the present invention, a spark plug comprises a center electrode having a distal end portion to which a first noble metal chip is secured by welding, and a ground electrode placed in face-to-face relationship with the center electrode through a spark gap while a second noble metal chip is secured to a surface of the ground electrode in face-to-face relationship with the center electrode. The second noble metal chip extends from the surface of the ground electrode toward the first noble metal chip in a given chip protruding length. Both the first and second noble metal chips are secured to base materials of the center electrode and the ground electrode, respectively, by laser weldings to allow both the first and second noble metal chips to be secured to the base materials through first and second fused portions, respectively, such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (1):
W₁≧41E₁(α′₁−α₁)(Tmax−Tmin)D₁³/{(L₁−X₁)σ₀₁} (1)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the first noble metal chip,
D₁ represents a tip diameter (unit: mm) of the first noble metal chip,
L₁ represents a chip protruding length (unit: mm) of the first noble metal chip,
X₁ represents a thickness (unit: mm) of the first fused portion occupied in the chip protruding length L₁ of the first noble metal chip,
Tmax represents the maximum temperature during the thermal shock cycles,
Tmin represents the minimum temperature during the termal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (2):
   W₂≧41E₂(α′₂−α₂)(Tmax−Tmin)D₂³/{(L₂−X₂)σ₀₂} (2)
   where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second noble metal chip,
D₂ represents a tip diameter (unit: mm) of the second noble metal chip,
L₂ represents a chip protruding length (unit: mm) of the second noble metal chip,
X₂ represents a thickness (unit: mm) of the second fused portion occupied in the chip protruding length L₂ of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

These features of the present invention defined above are found on experimental tests and forming the spark plug by permitting the noble metal chips to be secured to the center electrode and the ground electrode, respectively, as the spark discharge members both by laser welding enables a further increased bonding reliability of the noble metal chip to be realized.

According to a second aspect of the present invention, a spark plug comprises a center electrode having a distal end portion to which a first noble metal chip is secured by welding, and a ground electrode placed in face-to-face relationship with the center electrode through a spark gap. A second noble metal chip is secured to a surface of the ground electrode in face-to-face relationship with the center electrode. The second noble metal chip extends from the surface of the ground electrode toward the first noble metal chip in a given chip protruding length. Both the first and second noble metal chips are secured to base materials of the center electrode and the ground electrode, respectively, by resistance weldings such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (3):
W₁≧82E₁(α′₁−α₁)(Tmax−Tmin)D₁³/(L₁σ₀₁) (3)
where
α′₁, α₁, E₁, σ₀₁, D₁, L₁, X₁, Tmax and Tmin are, respectively, as defined in the formula (1); and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (4):
   W₂≧82E₂(α′₂−α₂)(Tmax−Tmin)D₂³/(L₂σ₀₂) (4)
   where
α′₂, α₂, E₂, σ₀₂, D₂, L₂, X₂, Tmax and Tmin are, respectively, as defined in the formula (2).

These features are obtained from experimental tests, and the spark plug can be manufactured by resistance welding under conditions specified above to allow the first and second noble metal chips to have desired bending strengths in an increased bonding reliability.

According to a third aspect of the present invention, a spark plug comprises a center electrode having a distal end portion to which a first noble metal chip is secured by welding, and a ground electrode placed in face-to-face relationship with the center electrode through a spark gap and a second noble metal chip secured to a surface of the ground electrode in face-to-face relationship with the center electrode. The second noble metal chip extends from the surface of the ground electrode toward the first noble metal chip in a given chip protruding length. The first noble metal chip is secured to base material of the center electrode by laser welding to allow the first noble metal chip to be secured to the base material through a fused portion while the second noble metal chip is secured to base material of the ground electrode by resistance welding such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (5):
W₁≧41E₁(α′₁−α₁)(Tmax−Tmin)D₁³/{(L₁−X₁)σ₀₁} (5)
where
α′₁, α₁, E₁, σ₁, D₁, L₁, X₁, Tmax and Tmin are, respectively, as defined in the formula (1); and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (6):
   W₂≧82E₂(α′₂−α₂)(Tmax−Tmin)D₂³/(L₂σ₀₂) (6)
   where
α′₂, α₂, E₂, σ₀₂, D₂, L₂, X₂, Tmax and Tmin are, respectively, as defined in the formula (2).

These features are found on experimental tests and use of such factors specified above enables the first noble metal chip to be secured to the center electrode by laser welding and the second noble metal chip to be secured to the ground electrode by resistance welding in a highly reliable manner to provide a further improved bonding reliability of the noble metal chip.

According to a fourth aspect of the present invention, a spark plug comprises a center electrode having a distal end portion to which a first noble metal chip is secured by welding, and a ground electrode placed in face-to-face relationship with the center electrode through a spark gap and a second noble metal chip secured to a surface of the ground electrode in face-to-face relationship with the center electrode. The second noble metal chip extends from the surface of the ground electrode toward the first noble metal chip in a given chip protruding length. The first noble metal chip is secured to base material of the center electrode by resistance welding while the second noble metal chip is secured to base material of the ground electrode by laser welding to allow the second noble metal chip to be secured to the base material of the ground electrode through a fused portion such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (7):
W₁≧82E₁(α′₁−α₁)(Tmax−Tmin)D₁³/(L₁σ₀₁) (7)
where
α′₁, α₁, E₁, σ₀₁, D₁, L₁, X₁, Tmax and Tmin are, respectively, as defined in the formula (1); and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (8):
   W₂≧41E₂(α′₂−α₂)(Tmax−Tmin)D₂³/(L₂σ₀₂) (8)
   where
α′₂, α₂, E₂, σ₀₂, D₂, L₂, X₂, Tmax and Tmin are, respectively, as defined in the formula (2).

These features are found on experimental tests and securing the first noble metal chip to the center electrode by resistance welding while securing the second noble metal chip to the ground electrode by laser welding under conditions specified above provides the spark plug with an increased bonding reliability.

The various factors of the spark plug have been set forth above in conjunction with bending strengths of the first and second noble metal chips for the purpose of permitting the first and second noble metal chips to heve respective desired bending strengths after the first and second noble metal chips have been subjected to thermal stress on heat cycles. The object of the present invention can be also achieved by specifying bending strengths of the first and second noble metal chips of the spark plug in a mint condition (e.g., a new one) just after welding. Such features will be discussed below.

According to a fifth aspect of the present invention, a spark plug comprises a center electrode having a distal end portion to which a first noble metal chip is secured by welding, and a ground electrode placed in face-to-face relationship with the center electrode through a spark gap and a second noble metal chip secured to a surface of the ground electrode in face-to-face relationship with the center electrode. The second noble metal chip extends from the surface of the ground electrode toward the first noble metal chip in a given chip protruding length. Both the first and second noble metal chips are secured to base materials of the center electrode and the ground electrode, respectively, by laser welding to allow both the first and second noble metal chips to be secured to the base materials through first and second fused portions, respectively, such that the first noble metal chip after laser welding has a first bending strength W₁ (unit: N) expressed by the following formula (9):
W₁≧61500E₁(α′₁−α₁)D₁³/{(L₁−X₁)σ₀₁} (9)
where
α′₁, α₁, E₁, σ₀₁, D₁, L₁, X₁, Tmax and Tmin are, respectively, as defined in the formula (1); and
that after the laser welding, the second noble metal chip has a second bending strength of W₂ (unit: N) expressed by the following formula (10):
   W₂≧65600E₂(α′₂α₂)D₂³/{(L₂−X₂)σ₀₂} (10)
   where
α′₂, α₂, E₂, σ₀₂, D₂, L₂, X₂, Tmax and Tmin are, respectively, as defined in the formula (2), and
wherein α′₂, α₂ and E₂ represent values at 950° C., and σ₀₂ represents a value at normal temperatures.

With such features of the present invention, laser welding is carried out under conditions specified above, and the first and second noble metal chips are are joined to the center electrode and the ground electrode as spark discharge members, respectively, through the respective fused portions in which each of the noble metal chips is fused to electrode base material, resulting in increased bonding reliability of the noble metal chip.

According to a sixth aspect of the present invention, a spark plug comprises a center electrode having a distal end portion to which a first noble metal chip is secured by welding, and a ground electrode placed in face-to-face relationship with the center electrode through a spark gap and a second noble metal chip secured to a surface of the ground electrode in face-to-face relationship with the center electrode. The second noble metal chip extends from the surface of the ground electrode toward the first noble metal chip in a given chip protruding length. Both the first and second noble metal chips are secured to base materials of the center electrode and the ground electrode, respectively, by resistance welding, such that the first noble metal chip after resistance welding has a first bending strength W₁ (unit: N) expressed by the following formula (11):
W₁≧123000E₁(α′₁−α₁)D₁³/(L₁σ₀₁) (11)
where
α′₁, α₁, E₁, σ₀₁, D₁ and L₁ are, respectively, as defined in the formula (1), and
wherein α′₁, α₁ and E₁ represent values at 900° C., and σ₀₁ represents a value at normal temperatures; and
that after resistance welding, the second noble metal chip has a second bending strength of W₂ (unit: N) expressed by the following formula (12):
   W₂≧131200E₂(α′₂−α₂)D₂³/(L₂σ₀₂) (12)
   where
α′₂, α₂, E₂, σ₀₂, D₂ and L₂ are, respectively, as defined in the formula (2), and
wherein α′₂, α₂ and E₂ represent values at 950° C., and σ₀₂ represents a value at the normal temperatures.

According to such features of the present invention, resistance welding is carried out under conditions specified above to secure the first and second noble metal chips to the center electrode and the ground electrode as spark discharge members, respectively, resulting in highly improved bonding reliability of the noble metal chip.

According to a seventh aspect of the present invention, a spark plug comprises a center electrode having a distal end portion to which a first noble metal chip is secured by welding, and a ground electrode placed in face-to-face relationship with the center electrode through a spark gap and a second noble metal chip secured to a surface of the ground electrode in face-to-face relationship with the center electrode. The second noble metal chip extends from the surface of the ground electrode toward the first noble metal chip in a given chip protruding length. The first noble metal chip is secured to base material of the center electrode by laser welding to allow the first noble metal chip to be secured to the base material through fused portion, in which the first noble metal chip, and the base material are fused to one another, and the second noble metal chip is secured to the ground electrode by resistance welding such that the first noble metal chip after laser welding has a first bending strength W₁ (unit: N) expressed by the following formula (13):
W₁≧61500E₁(α′₁−α₁)D₁³/{(L₁−X₁)σ₀₁} (13)
where
α′₁, α₁, E₁, σ₀₁, D₁ and L₁ are, respectively, as defined in the formula (1), and
wherein α′₁, α₁ and E₁ represent values at 900° C., and σ₀₁ represents a value at normal temperatures, and
that after resistance welding, the second noble metal chip has a second bending strength of W₂ (unit: N) expressed by the following formula (14):
   W₂≧131200E₂(α′₂−α₂)D₂³/(L₂σ₀₂) (14)
   where
α′₂, α₂, E₂, σ₀₂, D₂, L₂, X₂, Tmax and Tmin are, respectively, as defined in the formula (2), and
wherein α′₂, α₂ and E₂ represent values at 950° C., and σ₀₂ represents a value at the normal temperatures.

Under such conditions specified above, laser welding is carried out to secure the first noble metal chip to the center electrode and resistance welding is carried out to secure the second noble metal chip to the ground electrode, resulting in highly improved bonding reliability of the noble metal chip.

According to an eighth aspect of the present invention, a spark plug comprises a center electrode having a distal end portion to which a first noble metal chip is secured by welding, and a ground electrode placed in face-to-face relationship with the center electrode through a spark gap and a second noble metal chip secured to a surface of the ground electrode in face-to-face relationship with the center electrode. The second noble metal chip extends from the surface of the ground electrode toward the first noble metal chip in a given chip protruding length. The first noble metal chip is secured to base material of the center electrode by resistance welding and the second noble metal chip is secured to base material of the ground electrode by laser welding to allow the second noble metal chip to be secured to the base material through fused portion, in which the second noble metal chip, and the base material are fused to one another, such that the first noble metal chip after resistance welding has a first bending strength W₁ (unit: N) expressed by the following formula (15):
W₁≧123000E₁(α′₁−α₁)D₁³/(L₁σ₀₁) (15)
where
α′₁, α₁, E₁, σ₀₁, D₁ and L₁ are, respectively, as defined in the formula (1), and
wherein α′₁, α₁ and E₁ represent values at 900° C., and σ₀₁ represents a value at normal temperatures; and
that after the laser welding, the second noble metal chip has a second bending strength of W₂ (unit: N) expressed by the following formula (16):
   W₂≧65600E₂(α′₂−α₂)D₂³/{(L₂−X₂)σ₀₂} (
   where
α′₂, α₂, E₂, σ₀₂, D₂, L₂ and X₂ are, respectively, as defined in the formula (2), and
wherein α′₂, α₂ and E₂ represent values at 950° C., and σ₀₂ represents a value at the normal temperatures.

Under such conditions specified above, resistance welding is carried out to secure the first noble metal chip to the center electrode and laser welding is carried out to secure the second noble metal chip to the ground electrode through the fused portion, resulting in highly improved bonding reliability of the noble metal chip.

According to a ninth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by laser welding, securing the second noble metal chip to a distal end of base material of the ground electrode by laser welding and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The laser welding is carried out to allow both the first and second noble metal chips to be secured to the base materials through first and second fused portions, respectively, such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (17):
W₁≧41 E₁(α′₁−α₁)(Tmax−Tmin)D₁³/{(L₁−X₁)σ₀₁} (17)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at a minimum temperature (unit: ° C.), the second noble metal chip has a second bending strength of W₂ (unit: N) expressed by the following formula (18):
   W₂≧41E₂(α′₂−α₂)(Tmax−Tmin)D₂³/{(L₂−X₂)σ₀₂} (18)
   where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa),
D₂ represents a tip diameter (unit: mm) of the second noble metal chip,
L₂ represents the chip protruding length (unit: mm) of the second noble metal chip,
X₂ represents a thickness (unit: mm) of the second fused portion occupied in the chip protruding length L₂ of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

According to a tenth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by resistance welding, securing the second noble metal chip to a distal end of base material of the ground electrode by resistance welding and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The resistance weldings are carried out such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (19):
W₁≧82E₁(α′₁−α₁)(Tmax−Tmin)D₁³/(L₁σ₀₁) (19)
where
α′₁, α₁, E₁, σ₀₁, D₁, L₁, X₁, Tmax and Tmin are, respectively, as defined in the formula (17); and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (20):
   W₂≧41E₂(α′₂−α₂)(Tmax−Tmin)D₂³/(L₂σ₀₂) (20)
   where
α′₂, α₂, E₂, σ₂, D₂, L₂, Tmax and Tmin are, respectively, as defined in the formula (18).

According to an eleventh aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by laser welding, securing the second noble metal chip to a distal end of base material of the ground electrode by resistance welding and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The first noble metal chip is secured to base material of the center electrode by laser welding to allow the first noble metal chip to be secured to the base material through a fused portion while the second noble metal chip is secured to base material of the ground electrode by resistance welding such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (21):
W₁≧41E₁ (α′₁−α₁)(Tmax−Tmin)D₁³/{(L₁−X₁)σ₀₁} (21)
where
α′₁, α₁, E₁, σ₀₁, D₁, L₁, X₁, Tmax and Tmin are, respectively, as defined in the formula (17); and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (22):
   W₂≧82E₂(α′₂−α₂)(Tmax−Tmin)D₂³/(L₂σ₀₂) (22)
   where
α′₂, α₂, E₂, σ₀₂, D₂, L₂, Tmax and Tmin are, respectively, as defined in the formula (18).

According to a twelfth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by resistance welding, securing the second noble metal chip to a distal end of base material of the ground electrode by laser welding to allow the second noble metal chip to be secured to the base material of the ground electrode through a fused portion and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The resistance welding and the laser welding are carried out such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (23):
W₁≧82E₁(α′₁−α₁)(Tmax−Tmin)D₁³/(L₁σ₀₁) (23)
where
α′₁, α₁, E₁, σ₀₁, D₁, L₁, Tmax and Tmin are, respectively, as defined in the formula (17); and
wherein the the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (24):
   ti W₂≧41E₂(α′₂−α₂)(Tmax−Tmin)D₂³/(L₂σ₀₂) (24)
   where
α′₂, α₂, E₂, σ₀₂, D₂, L₂, X₂, Tmax and Tmin are, respectively, as defined in the formula (18).

According to a thirteenth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by laser welding, securing the second noble metal chip to a distal end of base material of the ground electrode by laser welding and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The laser welding is carried out to allow both the first and second noble metal chips to be secured to the base materials through first and second fused portions, respectively, such that the first noble metal chip after laser welding has a first bending strength W₁ (unit: N) expressed by the following formula (25):
W₁≧61500E₁(α′₁−α₁)D₁³/{(L₁−X₁)σ₀₁} (55)
where
α′₁, α₁, E₁, σ₀₁, D₁, L₁ and X₁ are, respectively, as defined in the formula (17), and
wherein α′₁, α₁ and E₁ represent values at 900° C. and σ₀₁ represents a value at normal temperatures; and
that after the laser welding, the second noble metal chip has a second bending strength of W₂ (unit: N) expressed by the following formula (26):
   W₂≧65600E₂(α′₂−α₂)D₂³/{(L₂−X₂)σ₀₂} (26)
   where
α′₂, α₂, E₂, σ₀₂, D₂, L₂ and X₂ are, respectively, as defined in the formula (18), and
wherein α′₂, α₂ and E₂ represent values at 950° C., and σ₀₂ represents a value at the normal temperatures.

According to a fourteenth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by resistance welding, securing the second noble metal chip to a distal end of base material of the ground electrode by resistance welding and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The resistance weldings are carried out such that the first noble metal chip after resistance welding has a first bending strength W₁ (unit: N) expressed by the following formula (27):
W₁≧123000E₁(α′₁−α₁)D₁³/(L₁σ₀₁) (27)
where
α′₁, α₁, E₁, σ₀₁, D₁ and L₁ are, respectively, as defined in the formula (17), and
wherein α′₁, α₁ and E₁ represent values at 900° C., and σ₀₁ represents a value at normal temperatures; and
that after resistance welding, the second noble metal chip has a second bending strength of W₂ (unit: N) expressed by the following formula (28):
   W₂≧131200E₂(α′₂−α₂)D₂³/(L₂σ₀₂) (28)
   where
α′₂, α₂, E₂, σ₀₂, D₂ and L₂ are, respectively, as defined in the formula (18), and
wherein α′₂, α₂ and E₂ represent values at 950° C., and σ₀₂ represents a value at the normal temperatures.

According to a fifteenth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by laser welding to allow the first noble metal chip to be secured to the base material through fused portion in which the first noble metal chip, and the base material are fused to one another, securing the second noble metal chip to a distal end of base material of the ground electrode by resistance welding and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The laser welding and the resistance welding are carried out such that the first noble metal chip after laser welding has a first bending strength W₁ (unit: N) expressed by the following formula (29):
W₁≧61500E₁(α′₁−α₁)D₁³/{(L₁−X₁)σ₀₁} (29)
where
α′₁, α₁, E₁, σ₀₁, D₁, L₁ and X₁ are, respectively, as defined in the formula (17), and
wherein α′₁, α₁ and E₁ represent values at 900° C., and σ₀₁ represents a value at normal temperatures; and
that after resistance welding, the second noble metal chip has a second bending strength of W₂ (unit: N) expressed by the following formula (30):
   W₂≧131200E₂(α′₂−α₂)D₂³/(L₂σ₀₂) (30)
   where
α′₂, α₂, E₂, σ₀₂, D₂ and L₂ are, respectively, as defined in the formula (18),
wherein α′₂, α₂ and E₂ represent values at 950° C., and σ₀₂ represents a value at the normal temperatures.

According to a sixteenth aspect of the present invention, there is provided a method of manufacturing a spark plug. The method comprises preparing a center electrode, a ground electrode, a first noble metal chip, and a second noble metal chip, securing the first noble metal chip to a distal end of base material of the center electrode by resistance welding, securing the second noble metal chip to a distal end of base material of the ground electrode by laser welding to allow the second noble metal chip to be secured to the base material of the ground electrode through a fused portion, in which the center electrode and the second noble metal the base material are fused to one another, and the second noble metal chip extends from a surface of the ground electrode toward the first noble metal chip in a given chip protruding length, and placing the ground electrode in face-to-face relationship with the center electrode and the second noble metal chip is positioned in face-to-face relationship with the first noble metal chip through a spark gap. The resistance welding and the laser welding are carried out such that the first noble metal chip after resistance welding has first bending strength W₁ (unit: N) expressed by the following formula (31):
W₁≧123000E₁(α′₁−α₁)D₁³/(L₁σ₀₁) (31)
where
α′₁, α₁, E₁, σ₀₁, D₁ and L₁ are, respectively, as defined in the formula (17), and
wherein α′₁, α₁ and E₁ represent values at 900° C., and σ₀₁ represents a value at normal temperatures; and
that after the laser welding, the second noble metal chip has a second bending strength of W₂ (unit: N) expressed by the following formula (32):
   W₂≧65600E₂(α′₂−α₂)D₂³/{(L₂−X₂)σ₀₂} (32)
   where
α′₂, α₂, E₂, σ₂, D₂, L₂ and X₂ are, respectively, as defined in the formula (18), and
wherein α′₂, α₂ and E₂ represent values at 950° C., and σ₀₂ represents a value at the normal temperatures.

### BRIEF DESCRIPTION OF THE DRAWINGS

For a better understanding of the present invention and to show how the same may be carried into effect, there will now be described by way of example only, specific embodiments and methods according to the present invention with reference to the accompanying drawings, in which:

FIG. 1 is a partially cross sectional view showing a spark plug of an embodiment according to the present invention;

FIG. 2A is an enlarged schematic cross sectional view showing a vicinity of a first structural example of the spark plug shown in FIG. 1;

FIG. 2B is an enlarged schematic cross sectional view showing a vicinity of a second structural example the spark plug shown in FIG. 1;

FIG. 3A is a further enlarged schematic cross sectional view showing the vicinity of the first structural example shown in FIG. 2A;

FIG. 3B is a further enlarged schematic cross sectional view showing a vicinity of the second structural example shown in FIG. 2B;

FIG. 4 is a graph illustrating evaluation results in bonding reliability of ground electrodes to each of which a noble metal chip is secured by laser welding;

FIG. 5 is an enlarged cross sectional view illustrating a breakaway (separation) rate of the noble metal chip;

FIG. 6 is a graph illustrating measured results on bending strengths of noble metal chips at mint (new) condition and after cold/hot thermal shock cycles when measured by altering chip materials and laser welding conditions;

FIG. 7 is an enlarged schematic cross sectional view illustrating a direction in which load is applied to the noble metal chip during measurement of bending strength;

FIG. 8 is a further enlarged cross sectional view illustrating the maximum stress σ max resulting from bending momentum occurring in a ground-electrode noble metal chip;

FIG. 9 is a table illustrating coefficients α₂ of a Pt—Rh spark plug and an Ir—Rh spark plug, differential coefficients (α′₂−α₂) of linear expansion with respect to base material, and Young's modulus E₂;

FIG. 10 is a view illustrating calculation results on thermal stress occurring at a bonding boundary layer between the chip and base material of the Pt—Rh spark plugs and Ir—Rh spark plugs and measured results on initial strengths (tensile strengths) at normal temperatures;

FIG. 11A is a schematic cross sectional view showing a first structural example of a spark plug of a second embodiment according to the present invention;

FIG. 11B is a schematic cross sectional view showing a second structural example of the spark plug of the second embodiment according to the present invention;

FIGS. 12A and 12B are, respectively, schematic views illustrating how loads are applied to the noble metal chip of the center electrode and the noble metal chip of the ground electrode during measuring steps to measure bending strengths of these noble metal chips;

FIG. 13A is a schematic view of one modified form of the ground electrode to be effective for eliminating thermal stress applied to the bonding boundary layer between the ground electrode and the ground-electrode noble metal chip;

FIG. 13B is a schematic view of another modified form of the ground electrode to be effective for eliminating thermal stress applied to the bonding boundary layer between the ground electrode and the ground-electrode noble metal chip;

FIG. 14 is a schematic cross sectional view showing a spark plug of a third embodiment according to the present invention;

FIG. 15 is a schematic cross sectional view showing a modified form of the spark plug of the third embodiment according to the present invention;

FIG. 16 is a schematic cross sectional view showing another modified form of the spark plug of the third embodiment according to the present invention; and

FIGS. 17A and 17B are schematic cross sectional views showing a spark plug of a fourth embodiment according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several views.

(First Embodiment)

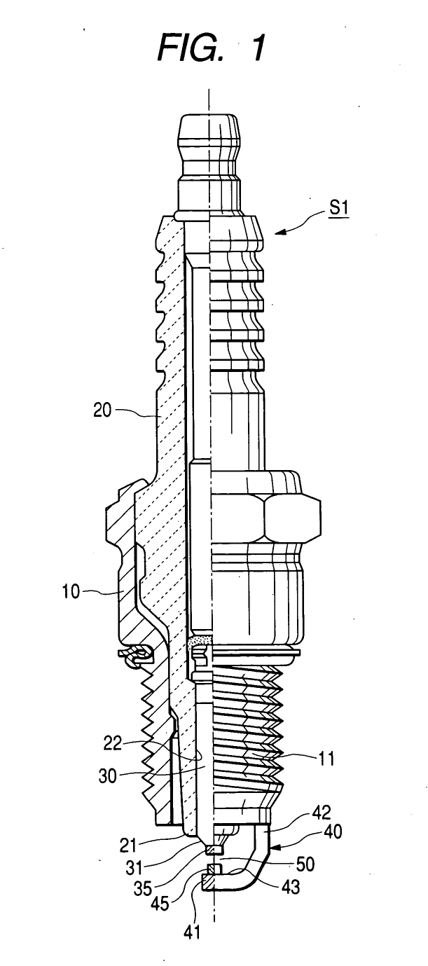

FIG. 1 is a cross sectional view in half of an overall structure of a spark plug S1 of a first embodiment according to the present invention.

The spark plug S1 is of the type that will be applied to an ignition plug for an automobile engine and adapted to be inserted to fixed by insertion into a threaded bore formed in an engine head (not shown) in which a combustion chamber of the engine is defined.

The spark plug S1 is comprised of a columnar metal shell (housing) 10, an insulator (porcelain insulator) 20 accommodated in and secured to the columnar metal shell 10, a center electrode 30 accommodated in the insulator 20, and a ground electrode 40 connected to and extending from the columnar metal shell 10 at a bottom end thereof. The metal shell 10 is made of conductive iron steel, such as low carbon steel, and formed with a threaded portion 11, serving as an engageable portion, through which the spark plug 10 can be screwed to an engine block (not shown). The porcelain insulator 20 is made of alumina ceramic (Al₂O₃) that is fixedly supported by the metal shell 10 and has a distal end 21 exposed outside from one end of the metal shell 10.

The center electrode 30 is secured to a shaft bore 22 of the porcelain insulator 20 and insulated electrically from the metal shell 10. The center electrode 30 is comprised of a columnar body that includes an inner member made of metallic material, such as Cu, having a high thermal conductivity and an outer member made of a metallic material, such as Ni-based alloy, having a high heat resistance and a corrosion resistance.

And, as shown in FIG. 1, the center electrode 30 has a distal end portion 31 projecting outward from the distal end portion 21 of the porcelain insulator 20. In such a way, the center electrode 30 is accommodated in the metal shell 10 under a situation where the distal end portion 31 is exposed to outside.

In the meanwhile, the ground electrode 40 is formed of a rectangular column, made of Ni-based alloy that contains principal component of Ni, and a root section 42 fixed to an end of the metal shell by welding and extending downward in a substantially L-shape configuration, and a distal end section 41 laterally extending from a lower end of the root section 42 such that an inner side surface (distal end side surface) 43 is placed in face-to-face relationship with the distal end portion 31 of the center electrode 30 through a spark gap 50.

Here, with respect to the ground electrode 40, the root section 42 corresponds to one end of the ground electrode 40 and the inner side surface 43 corresponds to an opposed surface of the ground electrode 40.

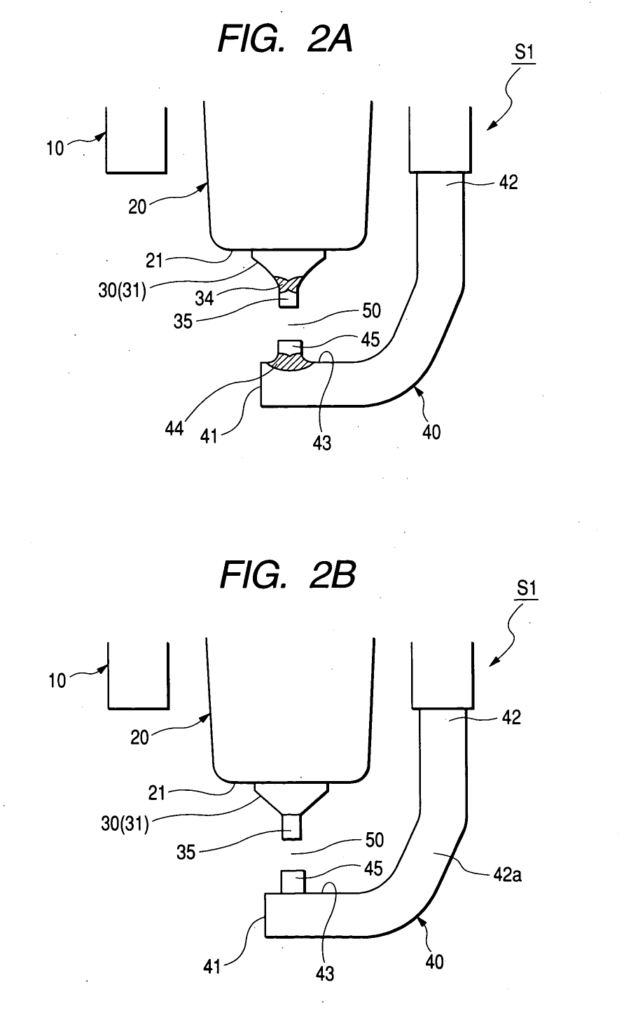

FIGS. 2A and 2B show schematic cross sectional views illustrating a vicinity of the spark gap 50 of the spark plug S1 of the presently filed embodiment in an enlarged structure.

FIG. 2A shows a first structural example in which both the center electrode 30 and the ground electrode 40 are comprised of noble metal chips (tips) 35 and 45, respectively, that are connected to an end surface of the distal end portion 31 of the center electrode 30 and the inner side surface 43 of the ground electrode 40, respectively, as spark gap members by laser welding.

FIG. 2B shows a second structural example in which both the center electrode 30 and the ground electrode 40 are comprised of columnar noble metal chips 35 and 45, respectively, that are secured to the end surface of the distal end portion 31 of the center electrode 30 and the inner side surface 43 of the ground electrode 40, respectively, as spark gap members by resistance welding.

With the structural examples shown in FIGS. 2A and 2B, the distal end portion 31 of the center electrode 30 and the distal end side surface 43 of the ground electrode 40 are placed in opposition via the spark gap 50 in a manner previously noted above, and the noble metal chips 35 and 45 are secured to the distal end portion 31 of the center electrode 30 and the distal end side surface 43 of the ground electrode 40, respectively, by laser welding or resistance welding.

With the first structural example shown in FIG. 2A, the noble metal chip (hereinafter referred to as a center-electrode noble metal chip) 35 and the noble metal chip (hereinafter referred to as a ground-electrode noble metal chip) 45 are secured to the distal end portion 31 of the center electrode 30 and the distal end side surface 43 of the ground electrode 40 by means of fused portions 34 and 44, respectively, in which the noble metal chips 35 and 45 and electrode base materials 30 and 40 are fused to one another by laser welding.

Further, with the second structural example shown in FIG. 2B, the center-electrode noble metal chip 35 and the ground-electrode noble metal chip 45 are secured to the electrode base materials 30 and 40 in structure with no formation of respective fused portions.

With the first and second structural examples shown in FIGS. 2A and 2B, both the noble metal chips 35 and 45 are made of columnar members, respectively, whose one ends are welded to the opposing surfaces 31, 43 of the respective electrodes 30 and 40. The spark gap 50 is defined by an air gap between distal ends of both the chips 35 and 45 to lie in a value of, for example, approximately 1 mm.

Each of the noble metal chips 35 and 45 is made of a noble metal such as Pt, Pt alloy, Ir or Ir alloy.

Further, if both of these noble metal chips 35 and 45 are made of alloy, it is preferred for alloy to contain at least one element of additives selected from the group consisting of Ir (iridium), Pt (white gold or platinum), Rh (rhodium), Ni (nickel), W (tungsten), Pd (palladium), Ru (ruthenium), Os (osmium), Al (aluminum), Y (yttrium) and Y₂O₃ (yttrium oxide or yttria).

Particularly, an example of the center-electrode noble metal chip 35 may be preferably made of Ir alloy that contains 50 Wt % or more of Ir and may preferably have an axis-orthogonal cross sectional area A1 in a range equal to or greater than 0.1 mm² and equal to or less than 1.15 mm².

In particular, an example of the ground-electrode noble metal chip 45 may be preferably made of Pt alloy that contains 50 Wt % or more of Pt and may preferably have an axis-orthogonal cross sectional area A2 in a range equal to or greater than 0.1 mm² and equal to or less than 1.15 mm².

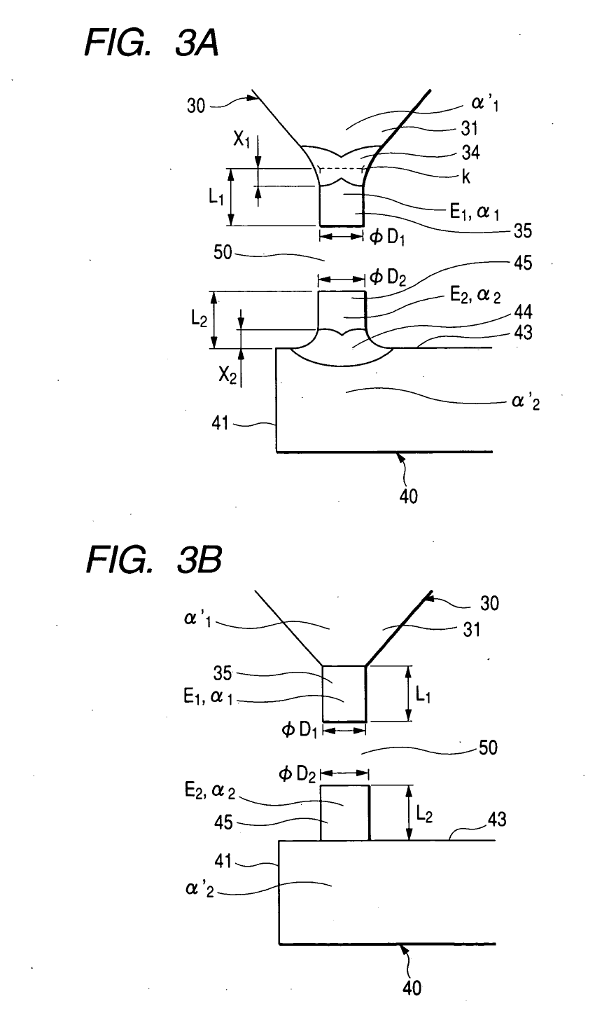

Here, FIGS. 3A and 3B are further enlarged views illustrating a vicinity of the spark gap 50 in the first and second structural examples shown in FIGS. 2A and 2B, and various component parts bear reference symbols indicative of dimensions and physical properties of the component parts.

With the first structural example shown in FIG. 3A, a reference symbol α′₁ is assigned to a coefficient of linear expansion of the center electrode 30; a reference symbol α₁ is assigned to a coefficient of linear expansion of the center-electrode noble metal chip 35; and E₁ (unit: MPa) is assigned to a Young's modulus. Also, though not shown, a reference symbol δ₀₁ (unit: MPa) is assigned to tensile strength of the center-electrode noble metal chip 35.

Further, φ D₁ (unit: mm) is assigned to a tip diameter of the center-electrode noble metal chip 35; a dimension L₁ (unit: mm) is assigned to a chip protruding length; and a dimension X₁ (unit: mm) is assigned to a thickness of the fused portion 34 shared in the chip protruding length L₁.

Also, in a case where the center-electrode noble metal chip 35 is secured to the electrode base material, i.e., the center electrode 30 as shown in FIG. 3A, the chip protruding length L₁ of the center-electrode noble metal chip 35 is defined as follows:

As shown in FIG. 3A, suppose that K is assigned to an intersecting point between a hypothetical surface, formed of an outer peripheral surface of the center-electrode noble metal chip 35 extending toward the fused portion 34, and a hypothetical surface, formed of an outer peripheral surface (tapered surface) of the distal end portion 31 of the center electrode 30 extending toward the fused portion 34. Then, the chip protruding length L₁ is defined as a function of a distance between the distal end of the center-electrode noble metal chip and the intersecting point K.

Moreover, with the first structural example shown in FIG. 3A, a reference symbol α′₂ is assigned to the coefficient of linear expansion of the ground electrode 40; a reference symbol of α₂ is assigned to the coefficient of linear expansion of the ground-electrode noble metal chip 45; and E₂ (unit: MPa) is assigned to a Young's modulus. Also, though not shown, a reference symbo δ₀₂ (unit: MPa) is assigned to tensile strength of the ground-electrode noble metal chip 45.

Further, a tip diameter of the ground-electrode noble metal chip 45 is designated as φ D₂ (unit: mm); a chip protruding length is designated as a dimension L₂ (unit: mm); and a thickness of the fused portion 34 that shares in the chip protruding length L₂ is designated as a dimension X₂ (unit: mm).

Additionally, with the second structural example shown in FIG. 3B, a reference symbol α′₁ is assigned to a coefficient of linear expansion of the center electrode 30; a reference symbol of α₁ is assigned to a coefficient of linear expansion of the center-electrode noble metal chip 35; and E₁ (unit: MPa) is assigned to a Young's modulus. Moreover, though not shown, a reference symbol δ₀₁ (unit: MPa) is assigned to tensile strength of the center-electrode noble metal chip 35.

Furthermore, with the second structural example shown in FIG. 3B, since no fused portion is present, a tip diameter of the center-electrode noble metal chip 35 is designated as φ D₁ (unit: mm) and a chip protruding length is designated as a dimension L₁ (unit: mm).

Moreover, with the second structural example shown in FIG. 3B, a reference symbol of α′₂ is assigned to a coefficient of linear expansion of the ground electrode 40; a reference symbol of α₂ is assigned to a coefficient of linear expansion of the ground-electrode noble metal chip 45; and E₂ (unit: MPa) is assigned to a Young's modulus. Besides, though not shown, a reference symbol δ₀₂ (unit: MPa) is assigned to a tensile strength of the ground-electrode noble metal chip 45.

In addition, with the second structural example shown in FIG. 3B, since no fused portion is present, a tip diameter of the ground-electrode noble metal chip 45 is designated as φ D₂ (unit: mm) and a chip protruding length is designated as a dimension L₂ (unit: mm). Even here, the chip protruding length L₂ is a length originating on the distal end side surface 43 of the ground electrode 40.

With the first and second structural examples shown in FIGS. 3A and 3B, the ground-electrode noble metal chip 45 extends from the distal end side surface 43 of the ground electrode 40 in face-to-face relationship toward the center electrode 30 preferably in the chip protruding length L₂ of a value equal to or greater than 0.3 mm.

With the spark plug S1 of the presently filed embodiment, unique structures are adopted in the respective structural examples, shown in FIGS. 3A and 3B, wherein the dimensions and physical properties set forth above are employed to allow bending strengths of the respective noble metal chips 35 and 45 to be defined in values falling within a given range.

[Study on Bending Strengths of Noble Metal Chips]

First, description is made of the first structural example (see FIG. 3A) previously described above wherein both the noble metal chips 35 and 45 are laser welded.

FIG. 4 is a graph illustrating evaluation results on a bonding reliability of the ground electrode 40 to which the ground-electrode noble metal chip 45 secured by laser welding.

In the graph of FIG. 4, the evaluation was conducted on test pieces wherein the ground-electrode noble metal chip 45 has a tip diameter of φ D₂=0.7 mm, a chip protruding length of L₂=0.8 mm and the fused portion 44 has a thickness of X₂=0.4 mm.

The evaluation tests have been conducted to obtain a breakaway (separation) rate of the ground-electrode noble metal chip 45 in terms of n=5 subsequent to cold/hot thermal shock cycle tests repeatedly conducted two hundred times at a maximum temperature of Tmax=950° C. for six minutes and at a minimum temperature of Tmin=150° C. (with thermal temperature difference ΔT=800° C.) for six minutes, and if the breakaway rate is less than 25%, then, it is judged that the bonding reliability is enhanced.

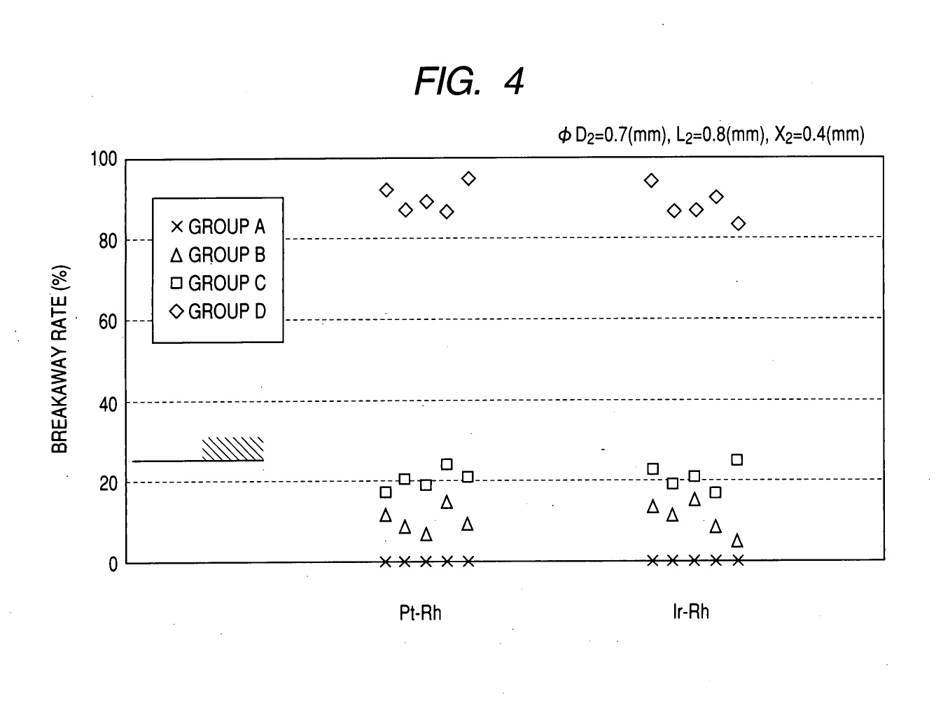

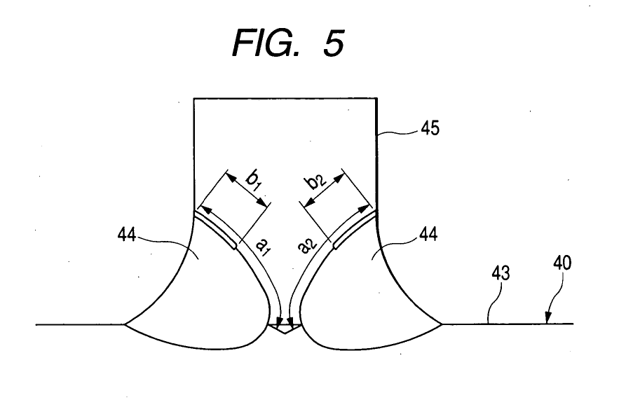

FIG. 5 is an enlarged cross sectional view illustrating the breakaway rate set forth above. As shown in FIG. 5, the breakaway rate represents a breakaway (separation) rate at a bonding boundary layer between the ground-electrode noble metal chip 45 and the fused portion 44. In FIG. 5, the lengths (lengths of joint) of areas that are bonded by nature at the boundary layer are designated as a₁ and a₂, and lengths (breakaway lengths) of areas which are broken away are designated as b1 and b2.

The length in the breakaway area and the breakaway configuration can be confirmed by observing the relevant cut surface through a metallographic microscope. And, the breakaway rate B is obtained by a formula expressed as:
B={(b1+b2)/(a1+a2)}×100%

Further, in the graph of FIG. 4, the evaluation has been conducted on the test pieces of the spark plugs, with a view to confirming how the chip materials influence the breakaway rate, the materials being Pt alloy (Pt—Rh) and Ir alloy (Ir—Rh). In addition, for the purpose of grasping a margin of the bonding reliability resulting from the laser welding condition, evaluation samples were prepared under four kinds of laser welding conditions.

A group “A” represents test pieces, which were welded under the greatest laser energy condition, i.e., the test pieces with the most excellent bonding reliability. In contrast, a group “D” represents other test pieces, which were welded under the least laser energy condition, i.e., the test pieces with the worst bonding reliability.

Groups “B” and “C” represent test pieces that were laser welded with laser energy intervening between those of groups “A” and “D” with group B showing results of laser welding with greater laser energy than that of the group “C”. Incidentally, different laser welding conditions were applied on the test pieces of the Pt—Rh spark plug and the test pieces of the Ir—Rh spark plug even in the same group.

As apparent from the graph of FIG. 4, the breakaway rate remarkably increases beyond a value of 25% in the group “D” that was obtained with the least laser energy and, hence, no bonding reliability can be enhanced. On the contrary, if the welding condition of the group “C” is satisfied even in the worst case, the breakaway rate can be remarkably reduced to a value below 25%, resulting in increased bonding reliability.

Further, FIG. 6 shows a graph representing bending strengths (N) of the spark plug test pieces that were prepared with different chip materials and under different laser welding conditions in the same manner as those of the spark plug test pieces shown in FIG. 4 whereupon evaluation tests were conducted with n=5 to measure bending strengths W₀₂ (unit: N) of the ground-electrode noble metal chips 45 in mint condition (at new stage) and bending strengths W₂ (unit: N) of the ground-electrode noble metal chips 45 after cold/hot thermal shock cycle tests. Also, the cold/hot thermal shock cycle tests were conducted under the same conditions as those discussed above.

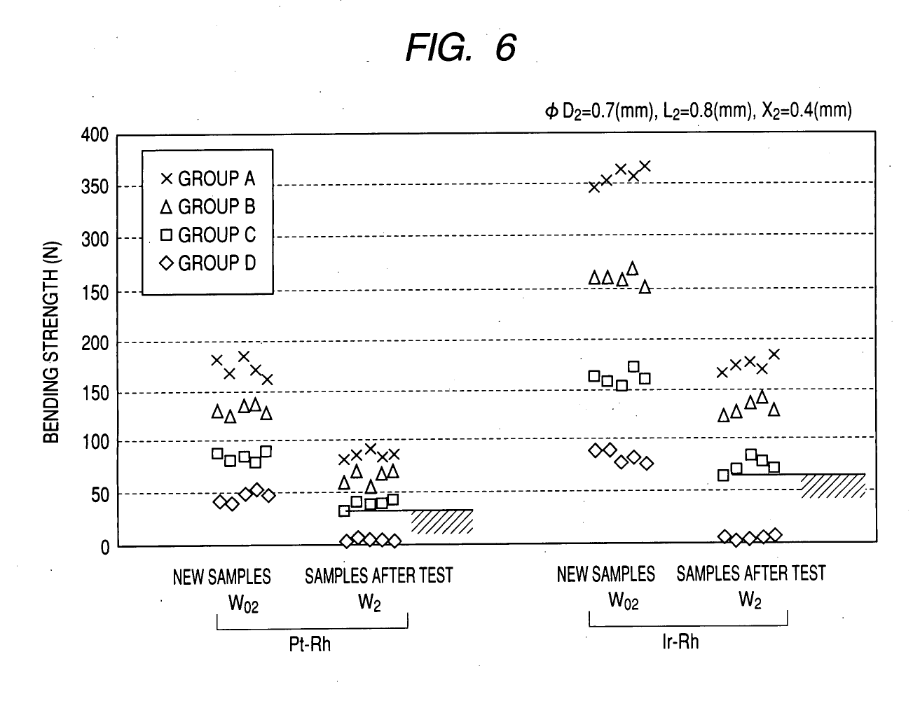

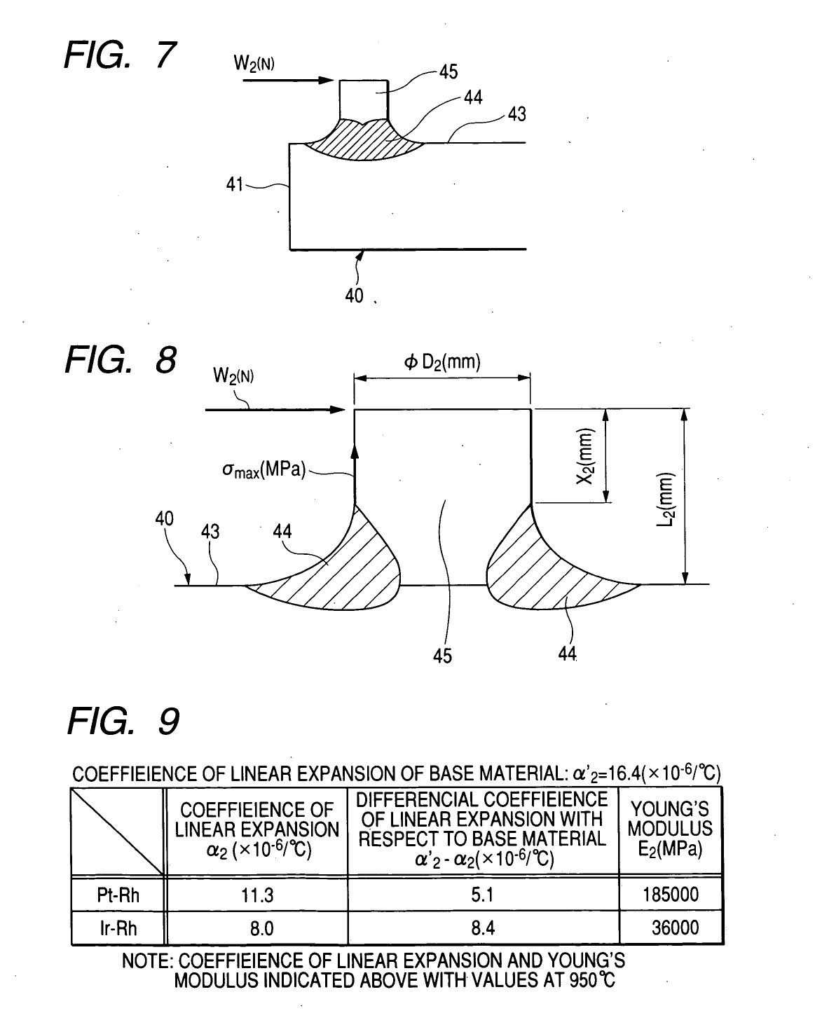

FIG. 7 is a view showing a direction in which load is applied to the ground-electrode noble metal chip of the spark plug during measurement on bending strength. Tests were conducted to measure bending strengths W₂ (unit: N) of the test pieces upon application of load to the distal end of the ground-electrode noble metal chip 45 in a direction perpendicular to the axis thereof as shown in FIG. 7.

As previously noted above, the ground-electrode noble metal chip 45 may preferably have the chip protruding length L₂ of a value equal to or greater than 0.3 mm.

This is because if L₂ lies in a value less than 0.3 mm, then, it becomes extremely difficult to measure bending strength with the resultant increased variation in measured dada and, on the contrary, if L₂ lies in a value greater than 0.3 mm, bending strength can be easily measured with less variation in measured data.

From test results shown in FIG. 6 set forth above, it appears that due to cold/hot thermal shock cycle tests, bending strengths of the spark plugs decrease regardless of chip materials and laser-welding conditions.

This seems to come from adverse affects resulting from breakaways at the bonding boundary layer, caused by thermal stress, and deterioration in material strength resulting from oxidation and annealing, and the breakaway rate of the group D, with poor bonding reliability, increases, resulting in a remarkable reduction in the bending strength to a value of nearly zero after cold/hot thermal shock cycle tests.

Furthermore, in order to enhance the bonding reliability (that is, the bonding reliability of a value less than 25%), it will be appreciated that the bending strength of the noble metal chip after cold/hot thermal shock cycle tests preferably falls in a range expressed by W₂≧32(N) for the Pt—Rh spark plug and W₂≧65(N) for the Pt—Rh spark plug.

FIG. 8 is an enlarged view of the ground-electrode noble metal chip 45 to represent how the maximum stress δ max (unit: MPa) occurs due to bending momentum. Using the dimensions shown in FIG. 8, the maximum stress δ max (unit: MPa) caused by bending momentum is expressed by a formula (1) given by

$$δ max = {W}_{2} ( {L}_{2} - {X}_{2} ) \times 32 / ( π {D}_{2}^{3} ) \\ = 32 \times ( 0.8 - 0.4 ) \times 32 / ( 0.73 π ) \\ = 380.12 \qquad ( 1 )$$

That is, it can be said that with the maximum stress δ max falling in a value less than 380 (MPa), the Pt—Rh spark plug is able to satisfy the requirement for a reliable bond.

Accordingly, the bending strength W₂ of the spark plug after cold/hot thermal shock cycle tests is given by the following formula (2) based on the formula (1):

$${W}_{2} ≧ π {D}_{2}^{3} δ max / \{ 32 ( {L}_{2} - {X}_{2} ) \} \\ = 380 π {D}_{2}^{3} δ max / \{ 32 ( {L}_{2} - {X}_{2} ) \} \\ = 37.3 {D}_{2}^{3} / ( {L}_{2} - {X}_{2} ) \qquad ( 2 )$$

Also, in case of the Ir—Rh spark plug, similar calculation results in bending strength W₂ as expressed by
W₂=75.8D₂³/(L₂−X₂) (3)

From this formula, it appears that the Ir—Rh spark plug is required to have bending strength approximately two times the bending strength of the Pt—Rh spark plug. That is, if the spark plug is made of different material, then, the requisite minimum bending strength after cold/hot thermal shock cycle tests varies.

Now, the resson for this is described below. FIG. 9 is a Table illustrating the coefficient α₂ (unit: ×10⁻⁶/° C.) of linear expansion, a difference (α′₂−α₂) (unit: ×10⁻⁶/° C.) in a coefficient of linear expansion between the noble metal chip and the base material, and Young's modulus E₂ (unit: MPa) for the chip materials Pt—Rh and Ir—Rh.

Here, the coefficient of linear expansion and Young's modulus are derived at a temperature of 900° C., and also, the base material (base material of the electrode) includes Ni-based alloy in the name of “INCONEL” (Trademark) with the coefficient α′₂ of linear expansion lying in a value of 16.4 (×10⁻⁶/° C.).

As indicated in FIG. 9, if materials of the noble metal chips are different, a difference appears in physical property (such as the coefficient α of linear expansion and the Young's modulus E) of material related to thermal stress that forms a main cause for the occurrence of breakaway of the noble metal chip, resulting in an increase in difference in the coefficient of linear expansion with respect to the base material, and if the spark plug is made of material Ir—Rh with a high Young's modulus, thermal stress acting on the bonding boundary layer becomes higher than that of the spark plug made of material Pt—Rh.

As a consequence, the spark plug made of Ir—Rh is hard to enhance the bonding reliability and it is difficult to make the bond more relilable with a spark plug made of Ir—Rh unless it should have a higher requisite minimum bending strength after cold/hot thermal shock cycle tests than that of the spark plug made of Pt—Rh.

Next, another consideration is made of reason why bending strength of the spark plug with Ir—Rh after cold/hot thermal shock cycle tests is required to have a value approximately two times bending strength of the spark plug with Pt—Rh.

Thermal stress, occurring when the ground-electrode noble metal chip 45 is secured to the electrode base material (ground electrode) 40 by welding, is expressed by E₂ (α′₂−α₂)ΔT/2, and in case of laser welding, the fused portion 44, in which the noble metal chip 45 and the base metal 40 are fused to one another, plays a role as a thermal-stress alleviation layer and thermal stress decreases by half, that is, to a value expressed by E₂ (α′₂−α₂)ΔT/2.

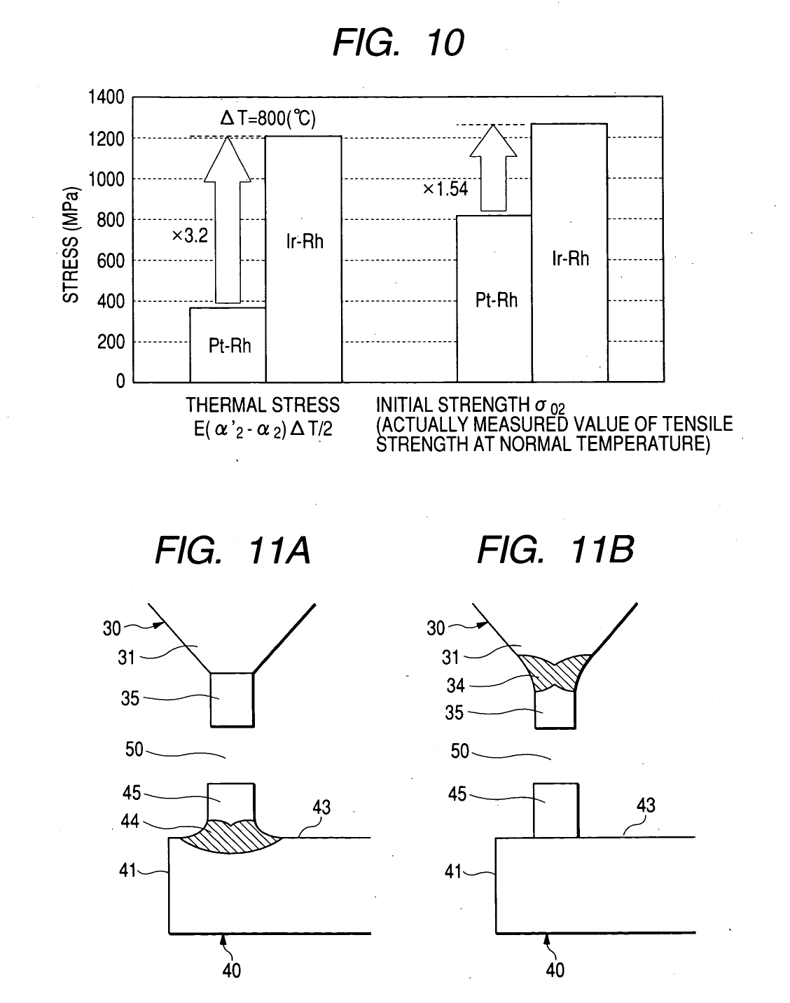

FIG. 10 is a view showing calculation results on thermal stress acting on the bonding boundary layer between the noble metal chip and the base material, of the spark plug made of Pt—Rh and the spark plug made of Ir—Rh. Also, FIG. 10 shows actually measured results on tensile strengths σ₀₂, as initial strengths, at room temperature of the ground-electrode noble metal chip 45 in respect of the spark plug made of Pt—Rh and the spark plug made of Ir—Rh.

As represented in FIG. 10, in case of material Pt—Rh, thermal stress occurs in the spark plug by a value 3.2 times that of the spark plug with material Pt—Rh and this is inconsistent with the requirement, set forth above, in that the bending strength needs to be two times that of the Pt—Rh spark plug. This seems to be based on a fact that the bonding reliability, related to the occurrence of breakaway of the noble metal chip at the bonding boundary layer, is related not only with thermal stress but also with the initial strength.

That is, even if thermal stress is great, the presence of increased initial strength enables the bonding reliability to be enhanced. In contrast, even if thermal stress is small, the presence of decreased initial strength results in deterioration in the bonding reliability.

As shown in FIG. 10, thermal stress, occurring at the bounding boundary layer of the Ir—Rh spark plug, lies in a value 3.2 times that of the Pt—Rh spark plug and, due to the presence of initial strength σ₀₂ advantageously lying in a value 1.54 times that of the Pt—Rh spark plug, the requisite minimum bending strength after cold/hot thermal stress cycle tests may be suffice to fall in a value 2.1 times (=3.2/1.54) that of the Pt—Rh spark plug in coincidence with the evaluation result set forth above.

Therefore, the influence of thermal stress and initial strength is added to the above formula (2), which in turn is rewritten below.

From the results shown in FIG. 10, thermal stress E₂ (α′₂−α₂)ΔT/2 of the Pt—Rh spark plug lies in a value of 377 MPa and initial strength σ₀₂ falls in a value of 830 MPa. From this, adding the influence of thermal stress and initial strength, resulting from parameters of the Pt—Rh spark plug, to the above formula (2) yields a formula (4) as follows:

$${W}_{2} ≧ 37.3 {D}_{2}^{3} / ( {L}_{2} - {X}_{2} ) \times \{ {E}_{2} ( {α}_{2}^{′} - {α}_{2} ) Δ T / 2 \} / 377 \times ( 830 / {σ}_{02} ) \\ = 41 {E}_{2} ( {α}_{2}^{′} - {α}_{2} ) ( T max - T min ) {D}_{2}^{3} / \{ ( {L}_{2} - {X}_{2} ) {σ}_{02} \} \qquad ( 4 )$$

where α′₂, α₂ and E₂ represent values at a maximum temperature Tmax during the cold/hot thermal shock cycle tests set forth above and σ₀₂ represents a value at the normal temperatures.

And, allowing the bending strength W₂ of the ground-electrode noble metal chip 45 to fall in a value in a range expressed by formula (4) enables the ground-electrode noble metal chip 45 to have a higher bonding reliability than that of the related art.

Although description has been made of a case where the ground-electrode noble metal chip 45 is secured to the ground electrode 40 by laser welding, it is needless to say that the use of similar introduction process provides similar advantageous effects even in a case where the center-electrode noble metal chip 35 is secured to the center electrode 30 by laser welding, and this has been confirmed.

That is, by using the coefficients σ′₁ of linear expansion of the center electrode 30, the coefficients α₁ of linear expansion of the center-electrode noble metal chip 35, Young's modulus E₁ (unit: MPa), tensile strength σ₀₁ (unit: MPa), a tip diameter φ D₁ (unit: mm), a chip protruding length L₁ (unit: mm) and a thickness X₁ (unit: mm) of the fused portion 34, bending strength W₁ (unit: N) of the center-electrode noble metal chip 35, resulting from cold/hot thermal shock tests conducted two hundred times at the maximum temperature Tmax (unit: ° C.) for six minutes and at a minimum temperature Tmin (unit: ° C.) for six minutes, has a value derived from formula (5) expressed below.
W₁=41E₁(α′₁−α₁)(Tmax−Tmin) D₁³/{(L₁−X₁)σ₀₁} (5)
where α′₁, α₁ and E₁ represent values at Tmax, and σ₀₁ represents a value at normal temperatures.

Thus, with the first structural example (see FIG. 3A) of the presently filed embodiment, bending strengths W₁ and W₂ of the center-electrode noble metal chip 35 and the ground-electrode noble metal chip 45 subsequent to cold/hot thermal shock cycle tests, set forth above, are defined in ranges given by formulae (5) and (4). Such a feature of the present invention is found from experimental tests and, according to the present invention, securing the noble metal chips 35 and 45 to the center electrode 30 and the ground electrode 40, respectively, by laser welding allows these noble metal chips to be secured to base materials of the associated electrodes through fused portions in which the noble metal chip and base electrode material are fused to one another. When carrying out laser welding, the fused portions of the noble metal chips 35 and 45 are formed in such a way to cause the noble metal chips 35 and 45 to have bending strengths W₁ and W₂, specified above, for thereby realizing a highly improved bonding reliability.

Thus, according to the first structural example, it becomes possible for the spark plug, which includes the noble metal chips 35 and 45 secured to the center electrode 30 and the ground electrode 40 as spark discharge members, respectively, to realize a further increased bonding reliability of the noble metal chips.

Next, description is made of the second structural example (see FIG. 3B) of the presently filed embodiment, that is, a case where the noble metal chips 35 and 45 are secured to the center electrode 30 and the ground electrode 40 by resistance welding.

Resistance welding differs from laser welding in that there exist no fused portions (thermal stress alleviation layers) in which the noble metal chips 35 and 45 and the electrode base materials 30 and 40 are fused to one another, and thermal stress doubles in contrast to that of laser welding, that is, a value expressed as {E₂(α′−α)ΔT/2}×2. Also, it is conceived that the thickness of the fused portions are given by X₁=0 and X₂=0.

Therefore, the bending strength W₁ (unit: N) of the center-electrode noble metal chip 35 subsequent to cold/hot thermal shock cycle tests, in cases where the center-electrode noble metal chip 35 is secured to the center electrode 30 by resistance welding, falls in a value of a range given by formula (6) based on formula (5).
W₁≧82E₁(α′₁−α₁)(Tmax−Tmin)D₁³/{(L₁σ₀₁} (6)
where α′₁, α₁ and E₁ represent values at Tmax, and σ₀₁ represents a value at normal temperatures.

Similarly, the bending strength W₂ (unit: N) of the ground-electrode noble metal chip 45 subsequent to cold/hot thermal shock cycle tests, in cases where the ground-electrode noble metal chip 45 is secured to the ground electrode 40 by resistance welding, falls in a value of a range given by formula (7) based on formula (4).
W₂≧82E₂(α′₂−α₂)(Tmax−Tmin)D₂³/{(L₂σ₀₂} (7)
where α′₂, α₂ and E₂ represent values at Tmax, and σ₀₂ represents a value at the normal temperatures.

Thus, with the second structural example (see FIG. 3B) of the presently filed embodiment, bending strengths W₁ and W₂ of the center-electrode noble metal chip 35 and the ground-electrode noble metal chip 45 subsequent to cold/hot thermal shock cycle tests, set forth above, are defined in values of ranges given by formulae (6) and (7).

In such a way, according to the second structural example, it becomes possible for the spark plug, which includes the noble metal chips 35 and 45 secured to the center electrode 30 and the ground electrode 40 as spark discharge members, respectively, to realize a further increased bonding reliability of the noble metal chip.

[Improvement over Bonding Reliability Under Actual Usage Environment]

Here, description is further made of the relationship between cold/hot thermal shock cycle test conditions and actual usage environment for the purpose of improving the securing reliabilities of the noble metal chips 35 and 45 in the presently filed embodiment.

Under the actual usage environment for automobiles in general use, multimillion cycles are repeatedly conducted for the center electrode with a thermal shock temperature difference in a range of ΔT=100˜500° C. and for the ground electrode with a thermal shock temperature difference in a range of ΔT=150˜550° C. In this connection, the ground electrode is exposed to the interior of the combudtion chamber more deeply than the center electrode and subjected to hard actual usage environments.

The cold/hot thermal shock cycle test conditions, under which the spark plug is able to enhance a safety factor of two (2) in such actual usage environment, takes a value of thermal shock temperature difference ΔT=750° C.×200 cycles for the central electrode and a value of thermal shock temperature difference ΔT=800° C.×200 cycles for the ground electrode.

Consequently, in cases where with the first structural example (see FIG. 3A), the center-electrode noble metal chip 35 is secured to the center electrode 30 by laser welding, the bending strength W₁ (unit: N) of the center-electrode noble metal chip 35 subsequent to cold/hot thermal shock cycle tests, which were conducted two hundred times at a maximum temperature of 900° C. for 6 minutes and a minimum temperature of 150° C. for 6 minutes, falls in a value given by formula (8).

$${W}_{1} ≧ 41 {E}_{1} ( {α}_{1}^{′} - {α}_{1} ) ( 900 - 150 ) {D}_{1}^{3} / \{ ( {L}_{1} - {X}_{1} ) {σ}_{01} \} \\ = 3075 \; 0 {E}_{1} ( {α}_{ 1}^{′} - {α}_{1} ) {D}_{1}^{3} / \{ ( {L}_{1} - {X}_{1} ) {σ}_{01} \} \qquad ( 8 )$$

where α′₁, α₁ and E₁ represent values at 900° C. and σ₀₁ represents a value at normal temperatures.

In the meanwhile, in cases where the ground-electrode noble metal chip 45 is secured to the ground electrode 40 by laser welding, the ground-electrode noble metal chip 45 takes bending strength W₂ (unit: N), after cold/hot thermal shock cycle tests which were conducted two hundred times at a maximum temperature of 950° C. for 6 minutes and a minimum temperature of 150° C. for 6 minutes, falling in a value given by formula (9) based on formula (4).

$${W}_{2} ≧ 41 {E}_{2} ( {α}_{2}^{′} - {α}_{2} ) ( 950 - 150 ) {D}_{2}^{3} / \{ ( {L}_{2} - {X}_{2} ) {σ}_{02} \} \\ = 32800 {E}_{2} ( {α}_{ 2}^{′} - {α}_{2} ) {D}_{2}^{3} / \{ ( {L}_{2} - {X}_{2} ) {σ}_{02} \} \qquad ( 9 )$$

where α′₂, α₂ and E₂ represent values at 950° C. and σ₀₂ represents a value at the normal temperatures.

Thus, with the first structural example (see FIG. 3A) of the presently filed embodiment, bending strengths W₁ and W₂ of the center-electrode noble metal chip 35 and the ground-electrode noble metal chip 45 subsequent to cold/hot thermal shock cycle tests, set forth above, are defined in the ranges given by formulae (8) and (9) discussed above.

In such a way, according to the first structural example, it becomes possible for the spark plug, which includes the noble metal chips 35 and 45 secured to the center electrode 30 and the ground electrode 40, respectively, as spark discharge members by laser welding, to realize a further increased bonding reliability of the noble metal chip.

Further, in cases where with the second structural example (see FIG. 3B), the center-electrode noble metal chip 35 is secured to the center electrode 30 by resistance welding, the center-electrode noble metal chip 35 takes bending strength W₁ (unit: N), at time subsequent to cold/hot thermal shock cycle tests, which were conducted two hundred times at a maximum temperature of 900° C. for 6 minutes and a minimum temperature of 150° C. for 6 minutes, which falls in a value given by formula (10).

$${W}_{1} ≧ 82 {E}_{1} ( {α}_{1}^{′} - {α}_{1} ) ( 900 - 150 ) {D}_{1}^{3} / ( {L}_{1} {σ}_{01} ) \\ = 61500 {E}_{1} ( {α}_{ 1}^{′} - {α}_{1} ) {D}_{1}^{3} / ( {L}_{1} {σ}_{01} ) \qquad ( 10 )$$

where α′₁, a₁ and E₁ represent values at 900° C. and σ₀₁ represents a value at normal temperatures.

In the meanwhile, in cases where the ground-electrode noble metal chip 45 is secured to the ground electrode 40 by resistance welding, the ground-electrode noble metal chip 45 takes bending strength W₂ (unit: N), at time subsequent to cold/hot thermal shock cycle tests which were conducted two hundred times at a maximum temperature of 950° C. for 6 minutes and a minimum temperature of 150° C. for 6 minutes, which falls in a value given by formula (11) based on formula (7).

$${W}_{2} ≧ 82 {E}_{2} ( {α}_{2}^{′} - {α}_{2} ) ( 950 - 150 ) {D}_{2}^{3} / ( {L}_{2} {σ}_{02} ) \\ = 32800 {E}_{2} ( {α}_{ 2}^{′} - {α}_{2} ) {D}_{2}^{3} / ( {L}_{2} {σ}_{02} ) \qquad ( 11 )$$

where α′₂, α₂ and E₂ represent values at 950° C. and a σ₀₂ represents a value at the normal temperatures.

Thus, with the second structural example (see FIG. 3B) of the presently filed embodiment, bending strengths W₁ and W₂ of the center-electrode noble metal chip 35 and the ground-electrode noble metal chip 45 subsequent to cold/hot thermal shock cycle tests, set forth above, can be defined in values given by formulae (10) and (11) discussed above. Such a feature of the present invention is found from experimental tests and, according to the present invention, securing the noble metal chips 35 and 45 to the center electrode 30 and the ground electrode 40 by resistance welding, respectively, allows these noble metal chips to be secured to base materials of the associated electrodes. When carrying out the resistance welding, the noble metal chips 35 and 45 are secured to respective base materials of the associated electrodes to cause the noble metal chips 35 and 45 to have bending strength W₁ and W₂, specified above, after cold/hot thermal shock cycles for thereby providing a highly improved bonding reliability.

In such a way, according to the second structural example, it becomes possible for the spark plugs, which includes the noble metal chips 35 and 45 secured to the center electrode 30 and the ground electrode 40 as spark discharge members, respectively, by resistance welding, to realize further increased securing reliabilities of the noble metal chips even under the severe actual usage environment.

[Study on Bending Strength of Noble Metal Chip at New Stage]

Next, description is made of the relationship between bending strength of a noble metal chip under a mint condition (that is, a spark plug just after welding) and the bending strength of the noble metal chip subsequent to cold/hot thermal shock cycle tests with reference to FIG. 6.

It is understood from FIG. 6 that in a range (that is, the spark plug test pieces covered in groups “A”, “B” and “C” whose noble metal chips are fixed by laser welding) where the bonding reliability is enhanced, the ground-electrode noble metal chip 45 of the new test piece has bending strength W₀₂, regardless of chip material, which is approximately two times greater than the bending strength W₂ of the test piece resulting from cold/hot thermal shock cycle tests as expressed in a relationship approximately given by W₀₂=W₂.

Accordingly, with the first structural example (see FIG. 3A), the bending strength W₀₂ (N) of the test piece after welding, in cases where the ground-electrode noble metal chip 45 is secured to the ground electrode 40 by laser welding, falls in a value expressed by formula (12) based on above formula (9).

$${W}_{02} = 2 {W}_{2} ≧ 2 \times 32800 {E}_{2} ( {α}_{2}^{′} - {α}_{2} ) {D}_{2}^{3} / \{ ( {L}_{2} - {X}_{2} ) {σ}_{02} \} \\ = 65600 {E}_{2} ( {α}_{ 2}^{′} - {α}_{2} ) {D}_{2}^{3} / \{ ( {L}_{2} - {X}_{2} ) {σ}_{02} \} \qquad ( 12 )$$

where α′₂, α₂ and E₂ represent values at 950° C. and σ₀₂ represents a value at the normal temperatures.

Similarly, in cases where the center-electrode noble metal chip 35 is secured to the center electrode 30 by laser welding, the bending strength W₀₁ (N) of the test piece after welding falls in a value expressed by formula (13) based on above formula (8)

$${W}_{01} = 2 {W}_{1} ≧ 2 \times 30750 {E}_{1} ( {α}_{1}^{′} - {α}_{1} ) {D}_{1}^{3} / \{ ( {L}_{1} - {X}_{1} ) {σ}_{01} \} \\ = 61500 {E}_{1} ( {α}_{ 1}^{′} - {α}_{1} ) {D}_{1}^{3} / \{ ( {L}_{1} - {X}_{1} ) {σ}_{01} \} \qquad ( 13 )$$

where α′₁, α₁ and E₁ represent values at 900° C. and σ₀₁ represents a value at normal temperatures.

Thus, with the first structural example (see FIG. 3A) of the presently filed embodiment, bending strengths W₀₁ and W₀₂ of the center-electrode noble metal chip 35 and the ground-electrode noble metal chip 45 (that is, new test pieces) after welding, can also be defined in values given by formulae (13) and (12), respectively, discussed above.

In such a way, according to the first structural example, it becomes possible for the spark plug, which includes the noble metal chips 35 and 45 secured to the center electrode 30 and the ground electrode 40, respectively, as spark discharge members by laser welding, to realize a further increased bonding reliability of the noble metal chip even under the severe actual usage environment.

Further, with the second structural example (see FIG. 3B), bending strength W₀₁ (unit: N) of the center-electrode noble metal chip 35 after welding in cases where the center-electrode noble metal chip 35 is secured to the center electrode 30 by resistance welding, falls in a value given by formula (14) based on above formula (10).

$${W}_{01} = 2 {W}_{1} ≧ 2 \times 61500 {E}_{1} ( {α}_{1}^{′} - {α}_{1} ) {D}_{1}^{3} / ( {L}_{1} {σ}_{01} \} \\ = 123000 {E}_{1} ( {α}_{ 1}^{′} - {α}_{1} ) {D}_{1}^{3} / ( {L}_{1} {σ}_{01} \} \qquad ( 14 )$$

where α′₁, α₁ and E₁ represent values at 900° C. and σ₀₁ represents a value at normal temperatures.

In the meanwhile, in cases where the ground-electrode noble metal chip 45 is secured to the ground electrode 40 by resistance welding, bending strength W₀₂ (N) of the ground-electrode noble metal chip 45 after welding, falls in a value given by formula (15) based on above formula (11).

$${W}_{02} ≧ 2 {W}_{2} ≧ 2 \times 65600 {E}_{2} ( {α}_{2}^{′} - {α}_{2} ) {D}_{1}^{3} / ( {L}_{2} {σ}_{02} \} = 131200 {E}_{2} ( {α}_{2}^{′} - {α}_{2} ) {D}_{2}^{3} / ( {L}_{2} {σ}_{02} \} \qquad ( 15 )$$

where α′₂, α₂ and E₂ represent values at 950° C. and σ₀₂ represents a value at the normal temperatures.

Thus, with the second structural example (see FIG. 3B) of the presently filed embodiment, bending strengths W₀₁ and W₀₂ of the center-electrode noble metal chip 35 and the ground-electrode noble metal chip 45 (that is, new test pieces) after welding, can also be defined in values given by formulae (14) and (15), respectively, discussed above.

In such a way, according to the second structural example, it becomes possible for the spark plug, which includes the noble metal chips 35 and 45 secured to the center electrode 30 and the ground electrode 40, respectively, as spark discharge members by resistance welding, to realize a further increased bonding reliability of the noble metal chip even under the severe actual usage environment.

[Other Features]

As previously noted above, with the presently filed embodiment, the center-electrode noble metal chip 35 may be preferably made of Ir alloy containing a main component of approximately 50% or more by weight of Ir while the ground-electrode noble metal chip 45 may be preferably made of Pt alloy containing a main component of approximately 50% or more by weight of Pt, and the noble metal chips 35 and 45 may preferably have axis-orthogonal cross sectional areas A₁ and A₂ falling in values equal to or greater than 0.1 mm² and equal to or less than 1.15 mm².

By using Ir alloy, which is material with a high melting point, as material for the center-electrode noble metal chip 35 that has a high probability of spark wear (loss) while using Pt alloy, which has an excellent oxidation resistant volatility, as material for the ground-electrode noble metal chip 45 that has a high probability of oxidizing volatile wear (loss), the spark plug is enabled to have a remarkably increased operating life.

Further, the noble metal chips 35 and 45 preferably have the axis-orthogonal cross sectional areas A₁ and A₂ in ranges equal to or greater than 0.1 mm² and equal to or less than 1.15 mm², respectively, because of the following reasons:

If the noble metal chips 35 and 45 have the axis-orthogonal cross sectional areas A₁ and A₂ of values less than 0.1 mm², extreme deterioration occurs in the heat radiation abilities of the noble metal chips to cause the tip temperatures to increase at an accelerating rate, resulting in the occurrence of various issues such as abnormal wear and pre-ignition.

In the meanwhile, if the noble metal chips 35 and 45 have the axis-orthogonal cross sectional areas A₁ and A₂ of values greater than 1.15 mm², deterioration occurs in ignitability. This is due to the fact in that cooling loss, resulting from noble metal chip during the growth of flame kernel, increases to cause a tendency of disturbing the growth of flame kernel.

Further, with the presently filed embodiment, the center-electrode noble metal chip 35 and the ground-electrode noble metal chip 45 may preferably contain at least one of the following additives selected from a group consisting of Ir, Pt, Ni, W, Pd, Ru, Os, Al, Y and Y₂O₃.

Through the use of such components as additives of the noble metal chips 35 and 45, anti-wear property can be further improved while providing an increase in chip strength, resulting in a capability of preventing the noble metal chip from splitting or cracking to be preferable in durability.

(Second Embodiment)

The first embodiment has been described with reference to the cases where both the center-electrode noble metal chip 35 and the ground-electrode noble metal chip 45 are laser welded or resistance welded.

Here, one of both the noble metal chips 35 and 45 may be laser welded whereas the other may be resistance welded.

FIGS. 11A and 11B are schematic cross sectional views illustrating enlarged structures related to a vicinity of a spark gap 50 of a spark plug of a second embodiment according to the present invention.

FIG. 11A shows a structure wherein the center-electrode noble metal chip 35 is secured to the center electrode 30 by resistance welding while the ground-electrode noble metal chip 45 is secured to the ground electrode 40 by laser welding, and FIG. 11B shows a structure wherein the center-electrode noble metal chip 35 is secured to the center electrode 30 by laser welding while the ground-electrode noble metal chip 45 is secured to the ground electrode 40 by resistance welding.

In such cases, it is needless to say that the noble metal chip, which is laser welded, is able to adopt the relationship associated with bending strength, resulting when laser welded as in the first embodiment set forth above, and the noble metal chip, which is resistance welded, is able to adopt the relationship associated with bending strength resulting when resistance welded as in the first embodiment set forth above.

In such a way, even with the presently filed embodiment, the spark plug, whose noble metal chips 35 and 45 are welded to the center electrode 30 and the ground electrode 40 as spark discharging materials, respectively, is able to realize a further increased bonding reliability of the noble metal chip.

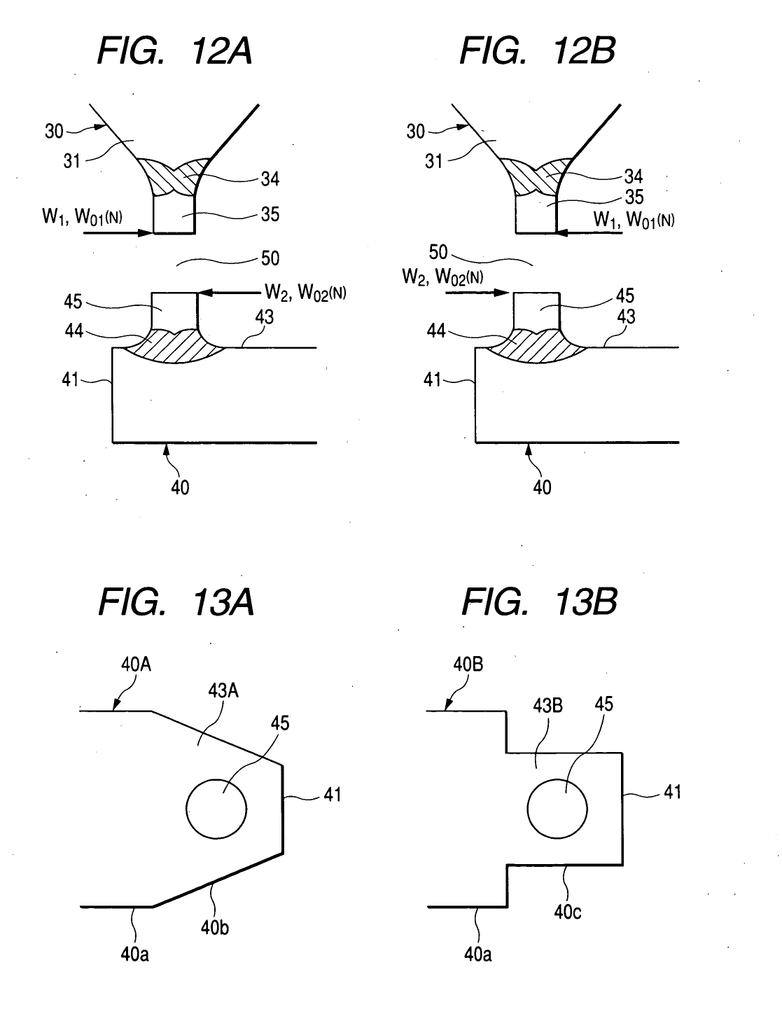

As shown in FIGS. 12A and 12B as structural examples, a direction in which load is exerted to the noble metal chips 35 and 45 to measure bending strengths may include any direction provided that it is perpendicular to the axes of the noble metal chips 35 and 45.

(Modified Forms)

Hereinafter, description is made of a structure of the ground electrode 40 suited for eliminating thermal stress to be applied to the bonding boundary layer.

FIGS. 13A and 13B are schematic enlarged views, as viewed from upper areas above distal end side surfaces (opposing surface) 43A and 43B of ground electrodes 40A and 40B, illustrating modified forms of the ground electrodes 40A and 40B suited for reducing thermal stress to be exerted to a bonding boundary layer between each of the ground electrode 40A and 40B and each of the ground-electrode noble metal chips 45, 45.

With one modified structure shown in FIG. 13A, the ground electrode 40A is comprised of a laterally extending base electrode portion 40a and tapered portion 40b extending from the base electrode portion 40a toward the distal end 41 and the distal end side surface 43A of the ground electrode 40A takes the form of a substantially trapezoid configuration, with narrowed distal end portion 41, to which the noble metal chip 45 is bonded. With the other modified structure shown in FIG. 13B, the ground electrode 40B is comprised of the laterally extending base electrode portion 40a and portions narrow portion 40c smaller in width than the base electrode portion 40a and extending from the base electrode portion 40a toward the distal end 41 and the distal end side surface 43B of the ground electrode 40B takes the form of a substantially square configuration, with narrowed distal end portion 41, to which the noble metal chip 45 is bonded. While the distal end portion 41 of each of the ground electrodes 40A and 40B shown in FIGS. 13A and 13B has been shown as having sharp edges at both sides, it may have rounded edges at both sides if desired.

With such structures, it is highly effective for the ground electrodes 40A and 40B to eliminate thermal stresses to be applied thereto, resulting in a capability of reducing thermal stresses to be applied to the bonding boundary layers set forth above to be preferable in durability.

(Third Embodiment)

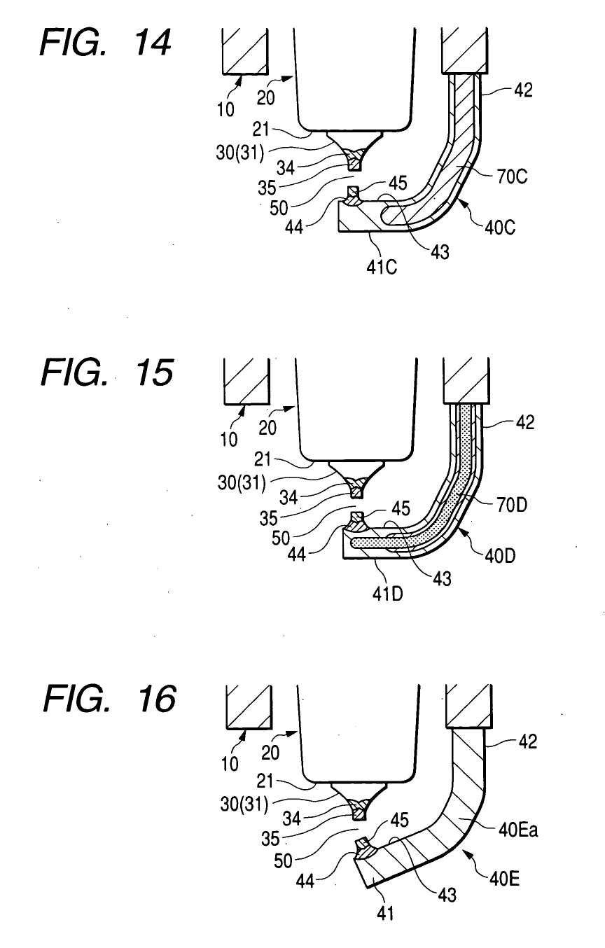

FIG. 14 is a schematic enlarged cross sectional view illustrating an internal structure of a spark plug of a third embodiment according to the present invention with a ground electrode 40C suited for reducing thermal stress to be exerted to the bonding boundary layer between the ground electrode 40C and the ground-electrode noble metal chip 45.

FIG. 15 is a schematic enlarged cross sectional view illustrating an internal structure of a modified form of the spark plug of the third embodiment shown in FIG. 14 with a ground electrode 40D suited for reducing thermal stress to be exerted to the bonding boundary layer between the ground electrode 40D and the ground-electrode noble metal chip 45.

The ground electrodes 40C and 40D, shown in FIGS. 14 and 15, respectively, internally include inside layers 70C and 70D each with higher thermal conductivity than that of base material (such as Ni-based alloy). With such structures, the temperatures of the distal end portions (each at a chip joint section) 41C and 41D of the ground electrodes 40C and 40D can be decreased, resulting in reduction in thermal stress to be applied to each bonding boundary layer to be preferable in durability.

More particularly, the ground electrode 40C, shown in FIG. 14, is comprised of the inside layer 70C, made of Cu, which includes one layer, and the ground electrode 4D, shown in FIG. 15, is comprised of the inside layer 70C composed of double layers, such as clad metals of Cu+Ni (in the form of stack bodies with Cu and Ni).

Further, FIG. 16 is a schematic enlarged cross sectional view illustrating another modified form of the spark plug of the third embodiment. In this modified form, a ground electrode 40E includes an inclined portion 40Ea, extending downward from the root section 42 at an obtuse angle with respect thereto, that has a lower end to which the noble metal chip 45 secured by welding. The layout in which the ground electrode 40E is inclined enables a length of the ground electrode 40 to be shortened. This also enables reduction in the temperature of the ground electrode 40E, resulting in reduction in thermal stress to be applied to the bonding boundary layer set forth above to be preferable in durability.

(Fourth Embodiment)

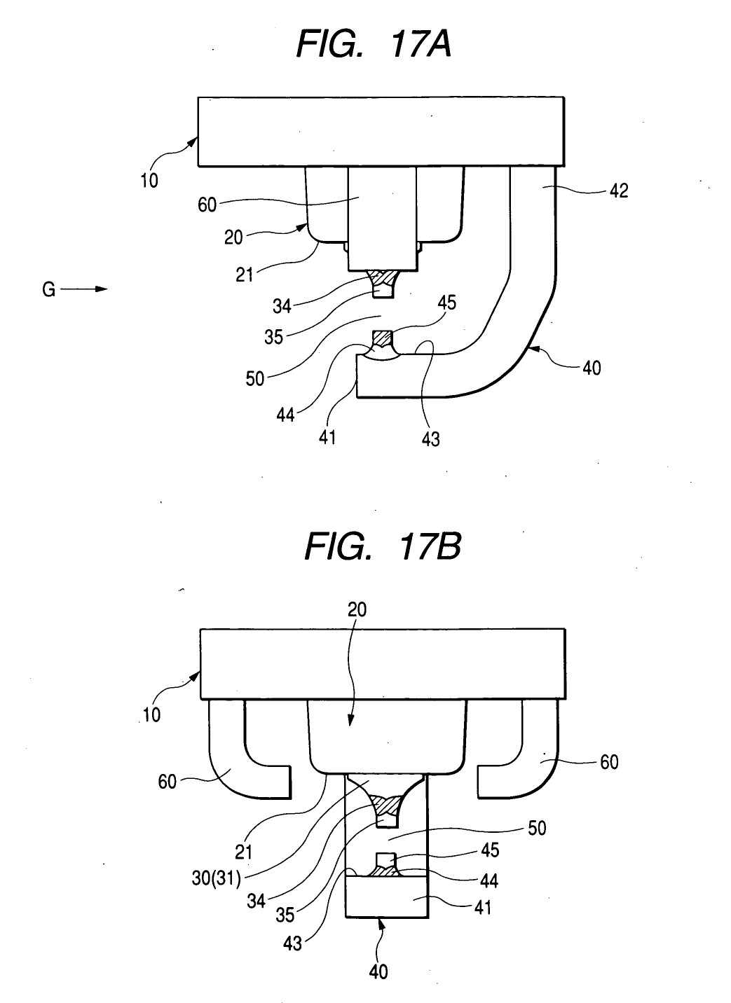

FIGS. 17A and 17B are schematic enlarged views illustrating a spark plug of a fourth embodiment according to the present invention. With the presently filed embodiment, the spark plug includes, in addition to the center electrode 30 and the ground electrode 40, auxiliary electrodes 60 whose lower distal ends are placed in face-to-face relationship with the distal end of the insulator 20. Also, FIG. 17B is a view as viewed in an arrow G in FIG. 17A.

With such a structure, when the spark plug is covered with soot, the auxiliary electrodes 60 are effective to provide an advantageous effect of burning off carbon adhered to the surface of the insulator 20, providing not only improvement in ignitability and bonding reliability, set forth above, but also improvement in anti-sooty property to be preferable in durability.

From the foregoing description, a number of advantages of the spark plug according to the present invention become evident:

(a) The second noble metal chip extends from the side surface of the ground electrode toward the first noble metal chip in the chip protruding length equal to or greater than 0.3 mm. If the chip protruding length is less than 0.3 mm, it becomes very difficult to measure the bending strength, resulting in an increase in variation in measured data. On the contrary, if the chip protruding length is equal to or greater than 0.3 mm, then, the bending strength of the noble metal chip can be easily measured in less variation in measurement to obtain reliable measured data.

(b) The provision of the inside member, with high heat conductivity, incorporated in the ground electrode provides a capability for a distal end (i.e., a tip securing area) of the ground electrode to lower the temperature for thereby eliminating thermal stress to be applied to the bonding boundary layer, resulting in an increase in durability.

(c) The existence of the auxiliary electrode associated with the insulator of the spark plug results in effectiveness to remove carbon (soot) from the distal end of the insulator, resulting in an increase in operating life of the spark plug.

(d) Due to the presence of the center electrode including the first noble metal chip, with a high probability in spark wear, which is made of of Ir alloy that is material with a high melting point and the ground electrode including the second noble metal chip, with a high probability in oxidation-volatile wear, which is made of Pt alloy that has oxidation-volatile wear resistance, the spark plug is able to have a remarkably increased operating life. The first and second noble metal chips are formed of columnar members each with an axis-orthogonal cross sectional area equal to or greater than 0.1 mm² and equal to or less than 1.15 mm². If the axis-orthogonal cross sectional area is less than 0.1 mm², extremely increased deterioration occurs in heat radiation ability to increase the tip temperature at an accelerated speed rate, resulting in the occurrence of issues such as abnormal wear and pre-ignition. On the contrary, if the axis-orthogonal cross sectional area is greater than 1.15 mm², deterioration occurs in ignitability of the spark plug. If cooling loss resulting from the noble metal chip increases during the formation of flame kernel, the growth of the flame kernel is disturbed.

(e) Adding at least one element of additives to the noble metal chip provides not only improved anti-wear property but also increased chip strength, resulting in the capability of preventing the noble metal chip from splitting or cracking due to high temperatures. Thus, high reliability is ensured.

(f) When the maximum temperature Tmax is set to the temperature of 900° C. and the minimum temperature Tmin is set to the temperature of 150° C., the first noble metal chip secured to the center electrode by laser welding is selected to have bending strength W₁ with a value expressed by the following formula:
W₁≧30750E₁(α′₁−α₁)D₁³/{(L₁−X₁)σ₀₁}
where
α′₁, α₁ and E₁ represent values at 900° C. and σ₀₂ represents a value at the normal temperatures. Further, when the maximum temperature Tmax is set to the temperature of 950° C. and the minimum temperature Tmin is set to the temperature of 150° C., the second noble metal chip of the ground electrode is selected to have bending strength with a value expressed by the following formula:
   W₂≧32800E₂(α′₂−α₂)D₂³/{(L₂−X₂)σ₀₂}
   where
α′₂, α₂ and E₂ represent values at 950° C. and σ₀₂ represents a value at the normal temperatures. With these features of the present invention, the first and second noble metal chips have bending strengths defined above at the specified maximum and minimum temperatures, whereby each of the first and second noble metal chips is enabled to have an improved bonding reliability.

(g) Further, when the maximum temperature Tmax is set to the temperature of 900° C. and the minimum temperature Tmin is set to the temperature 150° C., the first noble metal chip secured to the center electrode by resistance welding has bending strength W₁ with a value expressed by the following formula:
W₁≧61500E₁(α′₁−α₁)D₁³/(L₁σ₀₁)
where
α′₂, α₂ and E2 represent values at 900° C. and σ₀₂ represents a value at the normal temperatures. Additionally, when the maximum temperature Tmax is set to the temperature of 950° C. while the minimum temperature Tmin is set to the temperature of 150° C., the second noble metal chip secured to the ground electrode by resistance welding has second bending strength W₂ with a value expressed by the following formula:
   W₂≧65600E₂(α′₂−α₂)D₂ ³/(L₂σ₀₂)
   where
α′₂, α₂ and E₂ represent values at 950° C. and σ₀₂ represents a value at the normal temperatures. The first and second noble metal chips can be secured to the center electrode and the ground electrode, respectively, both by resistance welding to provide respective desired bending strengths for thereby providing a high bonding reliability particularly when the maximum and minimum temperatures are specified as set forth above.

(h) When carrying out laser welding to allow the first noble metal chip to be secured to the center electrode, the maximum temperature Tmax is set to the temperature of 900° C. and the minimum temperature Tmin is set to the temperature of 150° C. Thus, the first noble metal chip secured to the center electrode by laser welding has first bending strength W₁ with a value expressed by the following formula:
W₁≧30750E₁(α′₁−α₁)D₁³/{(L₁−X₁)σ₀₁}
where
α′₁, α₁ and E₁ represent values at 900° C. and σ₀₂ represents a value at the normal temperatures. Moreover, when carrying out resistance welding, the maximum temperature Tmax is set to the temperature of 950° C. while the minimum temperature Tmin is set to the temperature of 150° C., and the second noble metal chip secured to the ground electrode by resistance welding has second bending strength with a value expressed by the following formula:
   W₂≧65600E₂(α′₂−α₂)D₂³/(L₂σ₀₂)
   where
α′₂, α₂ and E₂ represent values at 950° C. and σ₂ represents a value at the normal temperatures. With these features of the present invention in addition to the features mentioned above, bending strengths of the first and second noble metal chips, particularly when the maximum and minimum temperatures are specified, are defined to provide increased bonding reliability of the noble metal chip.

(i) When carrying out ressitance welding to allow the first noble metal chip to be secured to the center electrode, the maximum temperature Tmax is set to the temperature of 900° C. while the minimum temperature Tmin is set to the temperature of 150° C. Thus, the first noble metal chip secured to the center electrode by resistance welding is selected to have first bending strength W₁ with a value expressed by:
W₁≧61500E₁(α′₁−α₁)D₁³/(L₁σ₀₁)
where
α′₁, α₁ and E₁ represent values at 900° C. and σ₀₂ represents a value at the normal temperatures. Further, when carrying out laser welding to allow the second noble metal chip to be secured to the ground electrode, the maximum temperature Tmax is set to the temperature of 950° C. while the minimum temperature Tmin is set to the temperature of 150° C., and the second noble metal chip secured to the ground electrode by laser welding has the second bending strength with a value expressed by:
   W₂≧32800E₂(α′₂−α₂)D₂³/{(L₂−X₂)σ₀₂}
   where
α′₂, α₂; and E₂ represent values at 950° C. and σ₀₂ represents a value at the normal temperatures. With these features of the present invention in addition to the features mentioned above, bending strengths of the first and second noble metal chips, particularly when the maximum and minimum temperatures are specified, are defined to provide increased bonding reliability of the noble metal chip.

(j) According to the manufacturing methods of the present invention, the spark plug can be manufactured in a highly reliable manner to have highly improved bonding reliability of the noble metal chip.

While various embodiments and modifications of the present invention are described above, it is contemplated that numerous alterations may be made thereto for particular applications without departing from the spirit and scope of the present invention. For example, while the noble metal chips have been described above as comprising the columnar members, it is to be noted that the noble metal chips may have a square shape or poligonal shape in cross section. In such case, a tip diameter may be read as a width of a noble metal chip. Thus, the illustrated embodiments and modifications must be read only as examples which have been set forth for the purpose of clarity and not as limitations of the invention as defined in the following claims.

1. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein both the first and second noble metal chips are secured to base materials of the center electrode and the ground electrode, respectively, by laser weldings to allow both the first and second noble metal chips to be secured to the base materials through first and second fused portions, respectively, such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (1):
W₁≧41E₁(α′₁−α₁)(Tmax−Tmin)D₁³/{(L₁−X₁)σ₀₁} (1)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (2):
W₂≧41E₂(α′₂−α₂)(Tmax−Tmin)D₂³/{(L₂−X₂)σ₀₂} (2)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the second fused portion occupied in the chip protruding length L₂ of the second noble metal chip,
Tmax represents the maximum temperature during the thermal shock cycles,
Tmin represents the minimum temperature during the thermal shock cycles, and
wherein α′₂, α₂ and E2 represent values at Tmax, and σ₀₂ represents a value at the normal temperatures.

2. The spark plug according to claim 1, wherein the second noble metal chip extends in the chip protruding length of a value equal to or greater than 0.3 mm, and wherein the given number of times includes 200 cycles and the given time interval includes six minutes.

3. The spark plug according to claim 1, wherein the ground electrode includes an inside layer with high heat conductivity.

4. The spark plug according to claim 1, further comprising an insulator through which the center electrode extends, and an auxiliary electrode having a lower distal end placed in face-to-face relationship a distal end of the insulator.

5. The spark plug according to claim 1, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

6. The spark plug according to claim 5, wherein the first noble metal chip of the center electrode and the second noble metal chip of the ground electrode contain at least one element of additives selected from a group consisting of Ir, Pt, Rh, Ni, W, Pd, Ru, Os, Al, Y and Y₂O₃.

7. The spark plug according to claim 1, wherein when the maximum temperature Tmax is set to the temperature of 900° C. while a minimum temperature Tmin is set to the temperature of 150° C., the first noble metal chip secured to the center electrode by laser welding has bending strength W₁ with a value expressed by the following formula (3):
W₁≧30750E₁(α′₁−α₁)D₁³/{(L₁−X₁)σ₀₁} (3)
where
α′₁, α₁ and E₁ represent values at 900° C. and σ₀₁ represents a value at the normal temperatures; and
wherein when the maximum temperature Tmax is set to the temperature of 950° C. while a minimum temperature Tmin is set to the temperature of 150° C., the second noble metal chip of the ground electrode has bending strength with a value expressed by the following formula (4):
W₂≧32800E₂(α′₂−α₂)D₂³/{(L₂−X₂)σ₀₂} (4)
where
α′₂, α₂ and E₂ represent values at 950° C. and σ₀₂ represents a value at the normal temperatures.

8. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein both the first and second noble metal chips are secured to base materials of the center electrode and the ground electrode, respectively, by resistance weldings such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (5):
W₁≧82E₁(α′₁−α₁)(Tmax−Tmin)D₁³/(L₁σ₀₁) (5)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (6):
W₂≧82E₂(α′₂−α₂)(Tmax−Tmin)D₂³/(L₂σ₀₂) (6)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

9. The spark plug according to claim 8, wherein the second noble metal chip extends in the chip protruding length of a value equal to or greater than 0.3 mm, and wherein the given number of times includes 200 cycles and the given time interval includes six minutes.

10. The spark plug according to claim 8, wherein the ground electrode includes an inside layer with high heat conductivity.

11. The spark plug according to claim 8, further comprising an insulator through which the center electrode extends, and an auxiliary electrode having a lower distal end placed in face-to-face relationship a distal end of the insulator.

12. The spark plug according to claim 8, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

13. The spark plug according to claim 12, wherein the first noble metal chip of the center electrode and the second noble metal chip of the ground electrode contain at least one of additives selected from a group consisting of Ir, Pt, Rh, Ni, W, Pd, Ru, Os, Al, Y and Y₂O₃.

14. The spark plug according to claim 8, wherein when the maximum temperature Tmax is set to the temperature of 900° C. and a minimum temperature Tmin is set to the temperature 150° C., the first noble metal chip secured to the center electrode by resistance welding has bending strength W₁ with a value expressed by the following formula (7):
W₁≧61500E₁(α′₁−α₁)D₁³/(L₁σ₀₁) (7)
where
α′₂, α₂ and E₂ represent values at 900° C. and σ₀₂ represents a value at the normal temperatures; and
wherein when the maximum temperature Tmax is set to the temperature of 950° C. while a minimum temperature Tmin is set to the temperature of 150° C., the second noble metal chip secured to the ground electrode by resistance welding has second bending strength W₂ with a value expressed by the following formula (8):
W₂≧65600E₂(α′₂−α₂)D₂³/(L₂σ₀₂) (8)
where
α′₂, α₂ and E₂ represent values at 950° C. and σ₀₂ represents a value at the normal temperatures.

15. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein the first noble metal chip is secured to base material of the center electrode by laser welding to allow the first noble metal chip to be secured to the base material through a fused portion while the second noble metal chip is secured to base material of the ground electrode by resistance welding such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (9):
W₁≧41 E₁(α′₁−α₁)(Tmax−Tmin)D₁³/{(L₁−X₁)σ₀₁} (9)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at a minimum temperature (unit: ° C.), the second noble metal chip has a second bending strength of W₂ (unit: N) expressed by the following formula (10):
W₂≧41E₂(α′₂−α₂)(Tmax−Tmin)D₂³/(L₂σ₀₂) (10)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

16. The spark plug according to claim 15, wherein the second noble metal chip extends in the chip protruding length of a value equal to or greater than 0.3 mm, and wherein the given number of times includes 200 cycles and the given time interval includes six minutes.

17. The spark plug according to claim 15, wherein the ground electrode includes an inside layer with high heat conductivity.

18. The spark plug according to claim 18, further comprising an insulator through which the center electrode extends, and an auxiliary electrode having a lower distal end placed in face-to-face relationship a distal end of the insulator.

19. The spark plug according to claim 15, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

20. The spark plug according to claim 19, wherein the first noble metal chip of the center electrode and the second noble metal chip of the ground electrode contain at least one of additives selected from a group consisting of Ir, Pt, Rh, Ni, W, Pd, Ru, Os, Al, Y and Y₂O₃.

21. The spark plug according to claim 15, wherein when the maximum temperature Tmax is set to the temperature of 900° C. while a minimum temperature Tmin is set to the temperature of 150° C., the first noble metal chip secured to the center electrode by laser welding has the first bending strength W₁ with a value expressed by the following formula (11):
W₁≧30750E₁(α′₁−α₁)D₁³/{(L₁−X₁)σ₀₁} (11)
where
α′₁, α₁ and E₁ represent values at 900° C. and σ₀₁ represents a value at the normal temperatures; and
wherein when the maximum temperature Tmax is set to the temperature of 950° C. while a minimum temperature Tmin is set to the temperature of 150° C., the second noble metal chip secured to the ground electrode by resistance welding has the second bending strength with a value expressed by the following formula (12):
W₂≧65600E₂(α′₂−α₂)D₂³/(L₂σ₀₂) (12)
where
α′₂, α₂ and E₂ represent values at 950° C. and σ₀₂ represents a value at the normal temperatures.

22. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein the first noble metal chip is secured to base material of the center electrode by resistance welding while the second noble metal chip is secured to base material of the ground electrode by laser welding to allow the second noble metal chip to be secured to the base material of the ground electrode through a fused portion, in which the center electrode and the second noble metal base material of the ground electrode are fused to one another, such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (13):
W₁≧82E₁(α′₁−α₁)(Tmax−Tmin)D₁³/(L₁σ₀₁) (13)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at the minimum temperature (unit: ° C.), the second noble metal chip has a second bending strength of W₂ (unit: N) expressed by the following formula (14):
W₂≧41E₂(α′₂−α₂)(Tmax−Tmin)D₂³/(L₂σ₀₂) (14)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the fused portion occupied in the chip protruding length L₁ of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

23. The spark plug according to claim 22, wherein the second noble metal chip extends in the chip protruding length of a value equal to or greater than 0.3 mm, and wherein the given number of times includes 200 cycles and the given time interval includes six minutes.

24. The spark plug according to claim 22, wherein the ground electrode includes an inside layer with high heat conductivity.

25. The spark plug according to claim 22, further comprising an insulator through which the center electrode extends, and an auxiliary electrode having a lower distal end placed in face-to-face relationship a distal end of the insulator.

26. The spark plug according to claim 22, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

27. The spark plug according to claim 26, wherein the first noble metal chip of the center electrode and the second noble metal chip of the ground electrode contain at least one of additives selected from a group consisting of Ir, Pt, Rh, Ni, W., Pd, Ru, Os, Al, Y and Y₂O₃.

28. The spark plug according to claim 22, wherein when the maximum temperature Tmax is set to the temperature of 900° C. while a minimum temperature Tmin is set to the temperature of 150° C., the first noble metal chip secured to the center electrode by resistance welding has the first bending strength W₁ with a value expressed by the following formula (15):
W₁≧61500E₁(α′₁−α₁)D₁³/(L₁σ₀₁) (15)
where
α′₁, α₁ and E₁ represent values at 900° C. and σ₀₁ represents a value at the normal temperatures; and
wherein when the maximum temperature Tmax is set to the temperature of 950° C. while a minimum temperature Tmin is set to the temperature of 150° C., the second noble metal chip secured to the ground electrode by laser welding has the second bending strength with a value expressed by the following formula (16):
W₂≧32800E₂(α′₂−α₂)D₂³/{(L₂−X₂)σ₀₂} (16)
where
α′₂, α₂ and E₂ represent values at 950° C. and σ₀₂ represents a value at the normal temperatures.

29. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein both the first and second noble metal chips are secured to base materials of the center electrode and the ground electrode, respectively, by laser weldings to allow both the first and second noble metal chips to be secured to the base materials through first and second fused portions, respectively, in each of which the noble metal chip and electrode material are fused to one another, such that the first noble metal chip after laser welding has a first bending strength W₁ (unit: N) expressed by the following formula (17):
W₁≧61500E₁(α′₁−α₁)D₁³/{(L₁−X₁)σ₀₁} (17)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip, and
wherein α′₁, al and E₁ represent values at 900° C. and σ₀₁ represents a value at normal temperatures; and
that after the laser welding, the second noble metal chip has a second bending strength of W₂ (unit: N) expressed by the following formula (18):
W₂≧65600E₂(α′₂−α₂)D₂³/{(L₂−X₂)σ₀₂} (18)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the second fused portion occupied in the chip protruding length L₂ of the center electrode and the second noble metal
wherein α′₂, α₂ and E₂ represent values at 950° C. and σ₀₂ represents a value at the normal temperatures.

30. The spark plug according to claim 29, wherein the second noble metal chip extends in the chip protruding length of a value equal to or greater than 0.3 mm, and wherein the given number of times includes 200 cycles and the given time interval includes six minutes.

31. The spark plug according to claim 29, wherein the ground electrode includes an inside layer with high heat conductivity.

32. The spark plug according to claim 29, further comprising an insulator through which the center electrode extends, and an auxiliary electrode having a lower distal end placed in face-to-face relationship a distal end of the insulator.

33. The spark plug according to claim 29, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

34. The spark plug according to claim 33, wherein the first noble metal chip of the center electrode and the second noble metal chip of the ground electrode contain at least one of additives selected from a group consisting of Ir, Pt, Rh, Ni, W, Pd, Ru, Os, Al, Y and Y₂O₃.

35. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein both the first and second noble metal chips are secured to base materials of the center electrode and the ground electrode, respectively, by resistance weldings such that the first noble metal chip after resistance welding has first bending strength W₁ (unit: N) expressed by the following formula (19):
W₁≧123000E₁(α′₁−α₁)D₁³/(L₁σ₀₁) (19)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip, and
wherein α′₁, α₁ and E₁ represent values at 900° C. and σ₀₁ represents a value at normal temperatures; and
that after resistance welding, the second noble metal chip has a second bending strength of W₂ (unit: N) expressed by the following formula (20):
W₂≧131200E₂(α′₂−α₂)D₂³/(L₂σ₀₂) (20)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the center electrode and the second noble metal
wherein α′₂, α₂ and E₂ represent values at 950° C. and σ₀₂ represents a value at the normal temperatures.

36. The spark plug according to claim 35, wherein the second noble metal chip extends in the chip protruding length of a value equal to or greater than 0.3 mm, and wherein the given number of times includes 200 cycles and the given time interval includes six minutes.

37. The spark plug according to claim 35, wherein the ground electrode includes an inside layer with high heat conductivity.

38. The spark plug according to claim 35, further comprising an insulator through which the center electrode extends, and an auxiliary electrode having a lower distal end placed in face-to-face relationship a distal end of the insulator.

39. The spark plug according to claim 35, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

40. The spark plug according to claim 39, wherein the first noble metal chip of the center electrode and the second noble metal chip of the ground electrode contain at least one of additives selected from a group consisting of Ir, Pt, Rh, Ni, W, Pd, Ru, Os, Al, Y and Y₂O₃.

41. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein the first noble metal chip is secured to base material of the center electrode by laser welding to allow the first noble metal chip to be secured to the base material through fused portion, in which the first noble metal chip, and the base material are fused to one another, and the second noble metal chip is secured to the ground electrode by resistance welding such that the first noble metal chip after laser welding has a first bending strength WI (unit: N) expressed by the following formula (21):
W₁≧61500E₁(α′₁−α₁)D₁³/{(L₁−X₁)σ₀₁} (21)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the fused portion occupied in the chip protruding length L₁ of the first noble metal chip, and
wherein α′₁, α₁ and E₁ represent values at 900° C. and σ₀₁ represents a value at normal temperatures; and
that after resistance welding, the second noble metal chip has a second bending strength of W₂ (unit: N) expressed by the following formula (22):
W₂≧131200E₂(α′₂−α₂)D₂³/(L₂σ₀₂) (22)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the center electrode and the second noble metal,
wherein α′₂, α₂ and E₂ represent values at 950° C. and σ₀₂ represents a value at the normal temperatures.

42. The spark plug according to claim 41, wherein the second noble metal chip extends in the chip protruding length of a value equal to or greater than 0.3 mm, and wherein the given number of times includes 200 cycles and the given time interval includes six minutes.

43. The spark plug according to claim 41, wherein the ground electrode includes an inside layer with high heat conductivity.

44. The spark plug according to claim 41, further comprising an insulator through which the center electrode extends, and an auxiliary electrode having a lower distal end placed in face-to-face relationship a distal end of the insulator.

45. The spark plug according to claim 41, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

46. The spark plug according to claim 45, wherein the first noble metal chip of the center electrode and the second noble metal chip of the ground electrode contain at least one of additives selected from a group consisting of Ir, Pt, Rh, Ni, W, Pd, Ru, Os, Al, Y and Y₂O₃.

47. A spark plug comprising:
a center electrode having a distal end portion to which a first noble metal chip is secured by welding;
a ground electrode placed in face-to-face relationship with the center electrode through a spark gap and a second noble metal chip secured to a surface of the ground electrode in face-to-face relationship with the center electrode;
wherein the second noble metal chip extends from the surface of the ground electrode toward the first noble metal chip in a given chip protruding length;
wherein the first noble metal chip is secured to base material of the center electrode by resistance welding and the second noble metal chip is secured to base material of the ground electrode by laser welding to allow the second noble metal chip to be secured to the base material through fused portion, in which the center electrode and the second noble metal the base material are fused to one another, such that the first noble metal chip after resistance welding has first bending strength W₁ (unit: N) expressed by the following formula (23):
W₁≧123000E₁(α′₁−α₁)D₁³/(L₁σ₀₁) (23)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip, and
wherein α′₁, α₁ and E₁ represent values at 900° C. and σ₀₁ represents a value at normal temperatures; and
that after the laser welding, the second noble metal chip has a second bending strength of W₂ (unit: N) expressed by the following formula (24):
W₂÷65600E₂(α′₂−α₂)D₂³/{(L₂−X₂)σ₀₂} (24)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the fused portion occupied in the chip protruding length L₂ of the center electrode and the second noble metal, and
wherein α′₂, α₂ and E₂ represent values at 950° C. and σ₀₂ represents a value at the normal temperatures.

48. The spark plug according to claim 47, wherein the second noble metal chip extends in the chip protruding length of a value equal to or greater than 0.3 mm, and wherein the given number of times includes 200 cycles and the given time interval includes six minutes.

49. The spark plug according to claim 47, wherein the ground electrode includes an inside layer with high heat conductivity.

50. The spark plug according to claim 47, further comprising an insulator through which the center electrode extends, and an auxiliary electrode having a lower distal end placed in face-to-face relationship a distal end of the insulator.

51. The spark plug according to claim 47, wherein the first noble metal chip includes a columnar member made of Ir alloy containing 50% by weight or more of Ir and having a cross sectional area of a value equal to or greater than 0.1 mm² and equal to or less than 1.15 mm², and the second noble metal chip includes a columnar member made of Pt alloy containing 50% by weight or more of Pt and having a cross sectional area of a value equal to or greater than 0.1 mm² and equal to or less than 1.15 mm².

52. The spark plug according to claim 51, wherein the first noble metal chip of the center electrode and the second noble metal chip of the ground electrode contain at least one of additives selected from a group consisting of Ir, Pt, Rh, Ni, W, Pd, Ru, Os, Al, Y and Y₂O₃.

53. A method of manufacturing a spark plug, the method comprising:
preparing a center electrode, a ground electrode, a first noble metal chip, and a second noble metal chip;
securing the first noble metal chip to a distal end of base material of the center electrode by laser welding;
securing the second noble metal chip to a distal end of base material of the ground electrode by laser welding and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the laser weldings are carried out to allow both the first and second noble metal chips to be secured to the base materials through first and second fused portions, respectively, such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (25):
W₁≧41E₁(α′₁−α₁)(Tmax−Tmin)D₁³/{(L₁−X₁)σ₀₁} (25)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at a minimum temperature (unit: ° C.), the second noble metal chip has a second bending strength of W₂ (unit: N) expressed by the following formula (26):
W₂≧41E₂(α′₂−α₂)(Tmax−Tmin)D₂³/{(L₂−X₂)σ₀₂} (26)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the second fused portion occupied in the chip protruding length L₂ of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

54. The method of manufacturing the spark plug according to claim 53, wherein the second noble metal chip extends in the chip protruding length of a value equal to or greater than 0.3 mm, and wherein the given number of times includes 200 cycles and the given time interval includes six minutes.

55. A method of manufacturing a spark plug, the method comprising:
preparing a center electrode, a ground electrode, a first noble metal chip, and a second noble metal chip;
securing the first noble metal chip to a distal end of base material of the center electrode by resistance welding;
securing the second noble metal chip to a distal end of base material of the ground electrode by resistance welding and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the resistance weldings for both bonding operations are carried out such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (27):
W₁≧82E₁(α′₁−α₁)(Tmax−Tmin)D₁³/(L₁σ₀₁) (27)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at a minimum temperature (unit: ° C.), the second noble metal chip has a second bending strength of W₂ (unit: N) expressed by the following formula (28):
W₂≧82E₂(α′₂−α₂)(Tmax−Tmin)D₂³/(L₂σ₀₂) (28)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₂ represents tensile strength (unit: MPa) of the second metal chip,
D₂ represents a tip diameter (unit: mm) of the second noble metal chip,
L₂ represents the chip protruding length (unit: mm) of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

56. The method of manufacturing the spark plug according to claim 55, wherein the second noble metal chip extends in the chip protruding length of a value equal to or greater than 0.3 mm, and wherein the given number of times includes 200 cycles and the given time interval includes six minutes.

57. A method of manufacturing a spark plug, the method comprising:
preparing a center electrode, a ground electrode, a first noble metal chip, and a second noble metal chip;
securing the first noble metal chip to a distal end of base material of the center electrode by laser welding;
securing the second noble metal chip to a distal end of base material of the ground electrode by resistance welding and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the first noble metal chip is secured to base material of the center electrode by laser welding to allow the first noble metal chip to be secured to the base material through a fused portion while the second noble metal chip is secured to base material of the ground electrode by resistance welding such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (29):
W₁≧41E₁(α′₁−α₁)(Tmax−Tmin)D₁³/{(L₁−X₁)σ₀₁} (29)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at a minimum temperature (unit: ° C.), the second noble metal chip has a second bending strength of W₂ (unit: N) expressed by the following formula (30):
W₂≧82E₂(α′₂−α₂)(Tmax−Tmin)D₂³/(L₂σ₀₂) (30)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

58. The method of manufacturing the spark plug according to claim 57, wherein the second noble metal chip extends in the chip protruding length of a value equal to or greater than 0.3 mm, and wherein the given number of times includes 200 cycles and the given time interval includes six minutes.

59. A method of manufacturing a spark plug, the method comprising:
preparing a center electrode, a ground electrode, a first noble metal chip, and a second noble metal chip;
securing the first noble metal chip to a distal end of base material of the center electrode by resistance welding;
securing the second noble metal chip to a distal end of base material of the ground electrode by laser welding to allow the second noble metal chip to be secured to the base material of the ground electrode through a fused portion and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the first noble metal chip is secured to base material of the center electrode by resistance welding while the second noble metal chip is secured to base material of the ground electrode by resistance welding such that after the spark plug is subjected to cold/hot thermal shock cycles repeatedly conducted a given number of times for a given time interval at a maximum temperature (unit: ° C.) and for the given time interval at a minimum temperature (unit: ° C.), the first noble metal chip has a first bending strength W₁ (unit: N) expressed by the following formula (31):
W₁≧82E₁(α′₁−α₁)(Tmax−Tmin)D₁³/(L₁σ₀₁) (31)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
Tmax represents the maximum temperature during the thermal shock cycles,
Tmin represents the minimum temperature during the thermal shock cycles, and
wherein α′₁, α₁ and E₁ represent values at Tmax, and σ₀₁ represents a value at normal temperatures; and
that after the ground electrode is subjected to the cold/hot thermal shock cycles conducted a given number of times for the given time interval at the maximum temperature (unit: ° C.) and for the given time interval at a minimum temperature (unit: ° C.), the second noble metal chip has a second bending strength of W₂ (unit: N) expressed by the following formula (32):
W₂≧41E₂(α′₂−α₂)(Tmax−Tmin)D₂³/(L₂σ₀₂) (32)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the fused portion occupied in the chip protruding length L₁ of the second noble metal chip,
Tmax represents the maximum temperature during the thermal shock cycles,
Tmin represents the minimum temperature during the thermal shock cycles, and
wherein α′₂, α₂ and E₂ represent values at Tmax, and σ₀₂ represents a value at the normal temperatures.

60. The method of manufacturing the spark plug according to claim 59, wherein the second noble metal chip extends in the chip protruding length of a value equal to or greater than 0.3 mm, and wherein the given number of times includes 200 cycles and the given time interval includes six minutes.

61. A method of manufacturing a spark plug, the method comprising:
preparing a center electrode, a ground electrode, a first noble metal chip, and a second noble metal chip;
securing the first noble metal chip to a distal end of base material of the center electrode by laser welding;
securing the second noble metal chip to a distal end of base material of the ground electrode by laser welding and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the laser weldings are carried out to allow both the first and second noble metal chips to be secured to the base materials through first and second fused portions, respectively, such that the first noble metal chip after laser welding has a first bending strength W₁ (unit: N) expressed by the following formula (33):
W₁≧61500E₁(α′₁−α₁)D₁³/{(L₁−X₁)σ₀₁} (33)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the first fused portion occupied in the chip protruding length L₁ of the first noble metal chip, and
wherein α′₁, α₁ and E₁ represent values at 900° C. and σ₀₁ represents a value at normal temperatures; and
that after the laser welding, the second noble metal chip has a second bending strength of W₂ (unit: N) expressed by the following formula (34):
W₂≧65600E₂(α′₂−α₂)D₂³/{(L₂−X₂)σ₀₂} (34)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the second fused portion occupied in the chip protruding length L₂ of the center electrode and the second noble metal
wherein α′₂, α₂ and E₂ represent values at 950° C. and σ₀₂ represents a value at the normal temperatures.

62. The method of manufacturing the spark plug according to claim 61, wherein the second noble metal chip extends in the chip protruding length of a value equal to or greater than 0.3 mm, and wherein the given number of times includes 200 cycles and the given time interval includes six minutes.

63. A method of manufacturing a spark plug, the method comprising:
preparing a center electrode, a ground electrode, a first noble metal chip, and a second noble metal chip;
securing the first noble metal chip to a distal end of base material of the center electrode by resistance welding;
securing the second noble metal chip to a distal end of base material of the ground electrode by resistance welding and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the resistance weldings are carried out such that the first noble metal chip after resistance welding has a first bending strength W₁ (unit: N) expressed by the following formula (35):
W₁≧123000E₁(α′₁−α₁)D₁³/(L₁σ₀₁) (35)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip, and
wherein α′₁, α₁ and E₁ represent values at 900° C. and σ₀₁ represents a value at normal temperatures; and
that after resistance welding, the second noble metal chip has a second bending strength of W₂ (unit: N) expressed by the following formula (36):
W₂≧131200E₂(α′₂−α₂)D₂³/(L₂σ₀₂) (36)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the center electrode and the second noble metal
wherein α′₂, α₂ and E₂ represent values at 950° C. and σ₀₂ represents a value at the normal temperatures.

64. The method of manufacturing the spark plug according to claim 63, wherein the second noble metal chip extends in the chip protruding length of a value equal to or greater than 0.3 mm, and wherein the given number of times includes 200 cycles and the given time interval includes six minutes.

65. A method of manufacturing a spark plug, the method comprising:
preparing a center electrode, a ground electrode, a first noble metal chip, and a second noble metal chip;
securing the first noble metal chip to a distal end of base material of the center electrode by laser welding to allow the first noble metal chip to be secured to the base material through fused portion in which the first noble metal chip, and the base material are fused to one another;
securing the second noble metal chip to a distal end of base material of the ground electrode by resistance welding and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the first noble metal chip is secured to base material of the center electrode by laser welding to allow the first noble metal chip to be secured to the base material through a fused portion while the second noble metal chip is secured to base material of the ground electrode by resistance welding such that the first noble metal chip after laser welding has a first bending strength W₁ (unit: N) expressed by the following formula (37):
W₁≧61500E₁(α′₁−α₁)D₁³/{(L₁−X₁)σ₀₁} (37)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip,
X₁ represents a thickness (unit: mm) of the fused portion occupied in the chip protruding length L₁ of the first noble metal chip, and
wherein α′₁, α₁ and E₁ represent values at 900° and σ₀₁ represents a value at normal temperatures; and
that after resistance welding, the second noble metal chip has a second bending strength of W₂ (unit: N) expressed by the following formula (38):
W₂≧131200E₂(α′₂−α₂)D₂³(L₂σ₀₂) (38)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the center electrode and the second noble metal
wherein α′₂, α₂ and E₂ represent values at 950° C. and σ₀₂ represents a value at the normal temperatures.

66. The method of manufacturing the spark plug according to claim 65, wherein the second noble metal chip extends in the chip protruding length of a value equal to or greater than 0.3 mm, and wherein the given number of times includes 200 cycles and the given time interval includes six minutes.

67. A method of manufacturing a spark plug, the method comprising:
preparing a center electrode, a ground electrode, a first noble metal chip, and a second noble metal chip;
securing the first noble metal chip to a distal end of base material of the center electrode by resistance welding;
securing the second noble metal chip to a distal end of base material of the ground electrode by laser welding to allow the second noble metal chip to be secured to the base material of the ground electrode through a fused portion, in which the center electrode and the second noble metal the base material are fused to one another, and the second noble metal chip extends from a surface of the ground electrode toward the first noble metal chip in a given chip protruding length; and
placing the ground electrode in face-to-face relationship with the center electrode and the second noble metal chip is positioned in face-to-face relationship with the first noble metal chip through a spark gap;
wherein the resistance welding and the laser welding are carried out such that the first noble metal chip after resistance welding has first bending strength W₁ (unit: N) expressed by the following formula (39):
W₁≧123000E₁(α′₁−α₁)D₁³/(L₁σ₀₁) (39)
where
α′₁ represents a coefficient of linear expansion of the center electrode,
α₁ represents a coefficient of linear expansion of the first noble metal chip of the center electrode,
E₁ represents a Young's modulus (unit: MPa) of the first noble metal chip,
σ₀₁ represents tensile strength (unit: MPa) of the second metal chip of the first noble metal chip,
D₁ represents a tip diameter (unit: mm) of the first noble metal chip,
L₁ represents the chip protruding length (unit: mm) of the first noble metal chip, and
wherein α′₁, α₁ and E₁ represent values at 900° C. and σ₀₁ represents a value at normal temperatures; and
that after the laser welding, the second noble metal chip has a second bending strength of W₂ (unit: N) expressed by the following formula (40):
W₂≧65600E₂(α′₂−α₂)D₂³/{(L₂−X₂)σ₀₂} (40)
where
α′₂ represents a coefficient of linear expansion of the ground electrode,
α₂ represents a coefficient of linear expansion of the second noble metal chip of the ground electrode,
E₂ represents a Young's modulus (unit: MPa) of the second noble metal chip,
σ₀₂ represents tensile strength (unit: MPa) of the second metal chip,
D₂ represents a tip diameter (unit: mm) of the second noble metal chip,
L₂ represents the chip protruding length (unit: mm) of the second noble metal chip,
X₂ represents a thickness (unit: mm) of the fused portion occupied in the chip protruding length L₂ of the center electrode and the second noble metal
wherein α′₂, α₂ and E₂ represent values at 950° C. and a σ₂ represents a value at the normal temperatures.

68. The method of manufacturing the spark plug according to claim 67, wherein the second noble metal chip extends in the chip protruding length of a value equal to or greater than 0.3 mm, and wherein the given number of times includes 200 cycles and the given time interval includes six minutes.
